(19) United States
(12) Patent Application Publication
(10) Pub. No.: US 2024/0129912 A1
(43) Pub. Date: Apr. 18, 2024

(54) CONFIGURED GRANT AND SEMI-PERSISTENT SCHEDULING FOR FREQUENT BANDWIDTH PART AND COMPONENT CARRIER SWITCHING

(71) Applicant: QUALCOMM Incorporated, San Diego, CA (US)

(72) Inventors: Ahmed Attia Abotabl, San Diego, CA (US); Marwen Zorgui, San Diego, CA (US); Ahmed Elshafie, San Diego, CA (US); Hung Dinh Ly, San Diego, CA (US)

(21) Appl. No.: 17/968,257

(22) Filed: Oct. 18, 2022

(51) Int. Cl. H04W 72/11; H04L 5/00; H04W 72/0457; H04W 72/1268; H04W 72/231

(52) U.S. Cl. CPC H04W 72/11; H04L 5/001; H04W 72/0457; H04W 72/1268; H04W 72/231

(57) ABSTRACT

Methods, systems, and devices for wireless communications are described. A communications device such as a user equipment (UE) may receive a control message that indicates at least one transmission configuration to apply for bandwidth part (BWP) switching between multiple BWPs, to apply for component carrier (CC) switching between multiple CCs, or both. The at least one transmission configuration may be associated with a plurality of scheduled transmissions (such as semi-persistent scheduling (SPS) or configured grant (CG) transmissions) associated with a BWP or CC configuration. The UE may then receive a switch command to switch from a first BWP to a second BWP, from a first CC to a second CC, or both. The UE may then transmit one or more scheduled transmissions in accordance with the at least one transmission configuration.

### INTRODUCTION

The following relates to wireless communications, including managing periodic scheduled transmissions associated with different time and frequency resources in wireless communications systems.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a UE is described. The method may include receiving a control message that indicates at least one transmission configuration to apply for bandwidth part (BWP) switching between multiple BWPs, to apply for component carrier (CC) switching between multiple CCs, or both, the at least one transmission configuration associated with a set of multiple scheduled transmissions. In some examples, the UE may receive a switch command to switch from a first BWP to a second BWP, from a first CC to a second CC, or both. In some examples, the UE may transmit one or more scheduled transmissions of the set of multiple scheduled transmissions in accordance with the at least one transmission configuration.

An apparatus for wireless communication at a UE is described. The apparatus may include a processor and memory coupled with the processor. The processor may be configured to receive a control message that indicates at least one transmission configuration to apply for BWP switching between multiple BWPs, to apply for CC switching between multiple CCs, or both, the at least one transmission configuration associated with a set of multiple scheduled transmissions. In some examples, the processor may be configured to receive a switch command to switch from a first BWP to a second BWP, from a first CC to a second CC, or both. In some examples, the processor may be configured to transmit one or more scheduled transmissions of the set of multiple scheduled transmissions in accordance with the at least one transmission configuration.

Another apparatus for wireless communication at a UE is described. The apparatus may include means for receiving a control message that indicates at least one transmission configuration to apply for BWP switching between multiple BWPs, to apply for CC switching between multiple CCs, or both, the at least one transmission configuration associated with a set of multiple scheduled transmissions. The apparatus may include means for receiving a switch command to switch from a first BWP to a second BWP, from a first CC to a second CC, or both. In some examples, the apparatus may include means for transmitting one or more scheduled transmissions of the set of multiple scheduled transmissions in accordance with the at least one transmission configuration.

A non-transitory computer-readable medium storing code for wireless communication at a UE is described. The code may include instructions executable by a processor to receive a control message that indicates at least one transmission configuration to apply for BWP switching between multiple BWPs, to apply for CC switching between multiple CCs, or both, the at least one transmission configuration associated with a set of multiple scheduled transmissions. In some examples, the code may include instructions executable by the processor further configured to receive a switch command to switch from a first BWP to a second BWP, from a first CC to a second CC, or both. In some examples, the code may include instructions executable by the processor further configured to transmit one or more scheduled transmissions of the set of multiple scheduled transmissions in accordance with the at least one transmission configuration.

In some examples of the method, apparatuses, and non-transitory computer-readable medium described herein, the at least one transmission configuration includes an uplink configured grant (CG) configuration, a semi-persistent scheduling (SPS) configuration, or both.

In some examples of the method, apparatuses, and non-transitory computer-readable medium described herein, the control message further includes an index that identifies each BWP of the multiple BWPs or each CC of the multiple CCs to which the at least one transmission configuration applies.

In some examples of the method, apparatuses, and non-transitory computer-readable medium described herein, the at least one transmission configuration indicates an activation of the one or more scheduled transmissions in the second BWP. In some examples, the method, apparatuses, and non-transitory computer-readable medium may include further operations, features, means, or instructions for transmitting the one or more scheduled transmissions of the set of multiple scheduled transmissions in the second BWP, in the second CC, or both, based on the activation.

In some examples of the method, apparatuses, and non-transitory computer-readable medium described herein, the at least one transmission configuration includes a single transmission configuration for the first BWP and the second BWP, the first CC and the second CC, or both.

In some examples of the method, apparatuses, and non-transitory computer-readable medium described herein, the at least one transmission configuration includes a common transmission configuration for the first BWP and the second BWP, a first dedicated transmission configuration for the first BWP, and a second dedicated transmission configuration for the second BWP.

In some examples of the method, apparatuses, and non-transitory computer-readable medium described herein, the at least one transmission configuration includes a common transmission configuration for the first CC and the second CC, a first dedicated transmission configuration for the first CC, and a second dedicated transmission configuration for the second CC.

In some examples of the method, apparatuses, and non-transitory computer-readable medium described herein, the at least one transmission configuration includes a first transmission configuration for the first BWP and a second transmission configuration for the second BWP, a first transmission configuration for the first CC and a second transmission configuration for the second CC, or both.

In some examples of the method, apparatuses, and non-transitory computer-readable medium described herein, the at least one transmission configuration indicates an activation of the one or more scheduled transmissions in the second BWP. In some examples, the method, apparatuses, and non-transitory computer-readable medium may include further operations, features, means, or instructions for receiving the release command, the deactivation command, or both, that indicates a release or deactivation of the one or more scheduled transmissions in the second BWP, the second CC, or both. In some examples, the method, apparatuses, and non-transitory computer-readable medium may include further operations, features, means, or instructions for deactivating at least one of the one or more scheduled transmissions in accordance with the release command, the deactivation command, or both.

In some examples of the method, apparatuses, and non-transitory computer-readable medium described herein, the at least one transmission configuration indicates activation of the one or more scheduled transmissions in the second BWP. In some examples, the method, apparatuses, and non-transitory computer-readable medium may include further operations, features, means, or instructions for communicating, via the second BWP, the second CC, or both, a scheduled transmission of the one or more scheduled transmissions using a second configuration of the at least one transmission configuration for the second BWP, the second CC, or both, after the defined time period.

In some examples of the method, apparatuses, and non-transitory computer-readable medium described herein, the multiple CCs include one or more CCs that at least partially overlap in a frequency domain or may be non-overlapping in the frequency domain.

In some examples of the method, apparatuses, and non-transitory computer-readable medium described herein, the at least one transmission configuration may be indicative of a linkage between the multiple BWPs, the multiple CCs, or both.

In some examples of the method, apparatuses, and non-transitory computer-readable medium described herein, the at least one transmission configuration includes one or more time domain allocation parameters, one or more frequency domain allocation parameters, one or more MCS parameters, one or more periodicity parameters, or any combination thereof.

In some examples of the method, apparatuses, and non-transitory computer-readable medium described herein, the control message includes a radio resource control (RRC) message.

A method for wireless communication at a network entity is described. The method may include outputting a control message that indicates at least one transmission configuration for BWP switching between multiple BWPs, for CC switching between multiple CCs, or both, the at least one transmission configuration associated with a set of multiple scheduled transmissions at a UE. In some examples, the method my include outputting a switch command to switch from a first BWP to a second BWP, from a first CC to a second CC, or both. In some examples, the method may include obtaining one or more scheduled transmissions of the set of multiple scheduled transmissions in accordance with the at least one transmission configuration.

An apparatus for wireless communication at a network entity is described. The apparatus may include a processor, and memory coupled with the processor. In some examples, the processor may be configured to output a control message that indicates at least one transmission configuration for BWP switching between multiple BWPs, for CC switching between multiple CCs, or both, the at least one transmission configuration associated with a set of multiple scheduled transmissions at a UE. In some examples, the processor may be configured to output a switch command to switch from a first BWP to a second BWP, from a first CC to a second CC, or both. In some examples, the processor may be configured to obtain one or more scheduled transmissions of the set of multiple scheduled transmissions in accordance with the at least one transmission configuration.

Another apparatus for wireless communication at a network entity is described. The apparatus may include means for outputting a control message that indicates at least one transmission configuration for BWP switching between multiple BWPs, for CC switching between multiple CCs, or both, the at least one transmission configuration associated with a set of multiple scheduled transmissions at a UE. The apparatus may further include means for outputting a switch command to switch from a first BWP to a second BWP, from a first CC to a second CC, or both. In some examples, the processor may further include means for obtaining one or more scheduled transmissions of the set of multiple scheduled transmissions in accordance with the at least one transmission configuration.

A non-transitory computer-readable medium storing code for wireless communication at a network entity is described. The code may include instructions executable by a processor to output a control message that indicates at least one transmission configuration for BWP switching between multiple BWPs, for CC switching between multiple CCs, or both, the at least one transmission configuration associated with a set of multiple scheduled transmissions at a UE. In some examples, the code may include instructions executable by a processor to output a switch command to switch from a first BWP to a second BWP, from a first CC to a second CC, or both. In some examples, the code may include instructions executable by a processor to obtain one or more scheduled transmissions of the set of multiple scheduled transmissions in accordance with the at least one transmission configuration.

In some examples of the method, apparatuses, and non-transitory computer-readable medium described herein, the at least one transmission configuration includes an uplink CG configuration, an SPS configuration, or both.

In some examples of the method, apparatuses, and non-transitory computer-readable medium described herein, the control message further includes an index that identifies each BWP of the multiple BWPs or each CC of the multiple CCs to which the at least one transmission configuration applies.

In some examples of the method, apparatuses, and non-transitory computer-readable medium described herein, the at least one transmission configuration indicates an activation of the one or more scheduled transmissions in the second BWP. In some examples, the method, apparatuses, and non-transitory computer-readable medium may include further operations, features, means, or instructions for obtaining the one or more scheduled transmissions of the set of multiple scheduled transmissions in the second BWP, in the second CC, or both, based on the activation.

In some examples of the method, apparatuses, and non-transitory computer-readable medium described herein, the at least one transmission configuration includes a single transmission configuration to apply for the first BWP and the second BWP, the first CC and the second CC, or both.

In some examples of the method, apparatuses, and non-transitory computer-readable medium described herein, the at least one transmission configuration includes a common transmission configuration to apply for the first BWP and the second BWP, and further indicates a first dedicated transmission configuration for the first BWP and a second dedicated transmission configuration for the second BWP.

In some examples of the method, apparatuses, and non-transitory computer-readable medium described herein, the at least one transmission configuration includes a common transmission configuration for the first CC and the second CC, and a first dedicated transmission configuration for the first CC and a second dedicated transmission configuration for the second CC.

In some examples of the method, apparatuses, and non-transitory computer-readable medium described herein, the at least one transmission configuration includes a first transmission configuration for the first BWP and a second transmission configuration for the second BWP, a first transmission configuration for the first CC and a second transmission configuration for the second CC, or both.

In some examples of the method, apparatuses, and non-transitory computer-readable medium described herein, the at least one transmission configuration indicates an activation of the one or more scheduled transmissions in the second BWP. In some examples, the method, apparatuses, and non-transitory computer-readable medium may include further operations, features, means, or instructions for outputting the release command, the deactivation command, or both, that indicates a release or deactivation of at least one of the one or more scheduled transmissions in the second BWP, the second CC, or both.

In some examples of the method, apparatuses, and non-transitory computer-readable medium described herein, the at least one transmission configuration indicates activation of the one or more scheduled transmissions in the second BWP. In some examples, the method, apparatuses, and non-transitory computer-readable medium may include further operations, features, means, or instructions for communicating, via the second BWP, the second CC, or both, a scheduled transmission of the one or more scheduled transmissions using a second configuration of the at least one transmission configuration for the second BWP, the second CC, or both, after the defined time period.

In some examples of the method, apparatuses, and non-transitory computer-readable medium described herein, the multiple CCs include one or more CCs that at least partially overlap in a frequency domain or may be non-overlapping in the frequency domain.

In some examples of the method, apparatuses, and non-transitory computer-readable medium described herein, the at least one transmission configuration may be indicative of a linkage between the multiple BWPs, the multiple CCs, or both.

In some examples of the method, apparatuses, and non-transitory computer-readable medium described herein, the at least one transmission configuration includes one or more time domain allocation parameters, one or more frequency domain allocation parameters, one or more MCS parameters, one or more periodicity parameters, or any combination thereof.

In some examples of the method, apparatuses, and non-transitory computer-readable medium described herein, the control message includes an RRC message.

### BRIEF DESCRIPTION OF THE DRAWINGS

FIGS. 1 and 2 illustrate examples of wireless communications systems that support CG and SPS for frequent BWP and CC switching in accordance with one or more aspects of the present disclosure.

FIGS. 3A-3C illustrate examples of BWP and CC configurations that support CG and SPS for frequent BWP and CC switching in accordance with one or more aspects of the present disclosure.

FIGS. 4A-4D illustrate example BWP switching configurations that support CG and SPS for frequent BWP and CC switching in accordance with one or more aspects of the present disclosure.

FIGS. 5A-5C illustrate example BWP configuration sharing implementations that support CG and SPS for frequent BWP and CC switching in accordance with one or more aspects of the present disclosure.

FIG. 6 illustrates an example of a transmission configuration activation scheme that supports CG and SPS for frequent BWP and CC switching in accordance with one or more aspects of the present disclosure.

FIG. 7 illustrates an example of a CC transmission configuration that supports CG and SPS for frequent BWP and CC switching in accordance with one or more aspects of the present disclosure.

FIG. 8 illustrates an example of a process flow that supports CG and SPS for frequent BWP and CC switching in accordance with one or more aspects of the present disclosure.

FIGS. 9 and 10 show diagrams of devices that support CG and SPS for frequent BWP and CC switching in accordance with one or more aspects of the present disclosure.

FIG. 11 shows a diagram of a communications manager that supports CG and SPS for frequent BWP and CC switching in accordance with one or more aspects of the present disclosure.

FIG. 12 shows a diagram of a system including a device that supports CG and SPS for frequent BWP and CC switching in accordance with one or more aspects of the present disclosure.

FIGS. 13 and 14 show diagrams of devices that support CG and SPS for frequent BWP and CC switching in accordance with one or more aspects of the present disclosure.

FIG. 15 shows a diagram of a communications manager that supports CG and SPS for frequent BWP and CC switching in accordance with one or more aspects of the present disclosure.

FIG. 16 shows a diagram of a system including a device that supports CG and SPS for frequent BWP and CC switching in accordance with one or more aspects of the present disclosure.

FIGS. 17 through 22 show flowcharts illustrating methods that support CG and SPS for frequent BWP and CC switching in accordance with one or more aspects of the present disclosure.

### DETAILED DESCRIPTION

Some wireless communications systems may implement energy saving techniques to improve network signaling overhead and overall energy expenditure. Some such energy saving techniques may include dynamic (e.g., RRC configured) switching between different communications configurations. For example, a communications device may implement different reference signaling configurations (e.g., channel state information reference signal (CSI-RS) configurations, demodulation reference signal (DMRS) configurations, tracking reference signal (TRS) configurations, among other reference signal configurations), antenna port configurations, transmission power configurations, and so on. In some examples, these different reference signaling configurations may be configured for use by a communications device via a BWP or CC configuration.

To support dynamic switching between these configurations, the communications device and the network may support frequent switching between multiple different BWPs or CCs (e.g., a device may receive a switch command to change from a first active BWP or CC to a second active BWP or CC, then back to the first BWP or CC). For example, the communications device may switch between one or more BWPs or CCs as often as the switching provides power savings to the communications device, the network, or both, or based on a configured threshold switching periodicity. In some cases, each BWP or CC may be configured with different BWP or CC configurations, for example, each BWP or CC may be RRC configured with different semi-persistent scheduling (SPS) or CG configured grant (CG) configurations, time-domain allocation parameters, frequency-domain allocation parameters, MCS parameters, and periodicity parameters.

In some cases, however, frequent switching between different BWPs or CCs may introduce signaling interruption when switching occurs during an activated transmission configuration for one or more scheduled transmissions such as an SPS or CG configuration that schedules SPS or CG communications within a BWP or a CC. For example, the UE may decode a downlink control channel to obtain downlink control information (DCI) (e.g., activation DCI) that includes a grant or assignment for a retransmission or for activation or re-activation of a first SPS or CG configuration while operating in a first BWP or CC, and then switches to a different BWP or CC which as a different SPS or CG configuration, the UE may deactivate the first SPS or CG configuration and activate the second SPS or CG configuration. Such activation and deactivation of the SPS or CG configurations may reduce overall communications efficiency for SPS or CG communications scheduled by the corresponding SPS or CG configurations (e.g., the SPS or CG could be dropped or otherwise interrupted based on the switching) and may increase signaling overhead and power expenditure based on the transmission of multiple different activation DCI for the different SPS or CG configurations.

To support efficient scheduling of SPS and CG communications via corresponding SPS or CG configurations for relatively frequent BWP or CC switching, a communications device such as a UE may receive a configuration (e.g., via RRC) for uplink CG or uplink SPS that is tied to (e.g., associated with) more than one BWP or CC. For example, the UE may receive a configuration that indicates (via an index) multiple BWPs or CCs that the UE should apply a specific SPS or CG configuration. In such cases, the UE can receive a single activation DCI to activate the SPS or CG across multiple BWPs or CCS, and may maintain the activated SPS or CG after switching to a different BWP or CC. In some examples, the SPS or CG configuration may be configured under the CC configuration or may be configured under one of the BWP configurations. In some other examples, the SPS or CG configuration may be partially shared between CCs or BWPs.

Such dynamic configuration of SPS, CG, or both, across multiple different BWPs or CCs may improve overall network signaling overhead and network power expenditure. For example, the network may reduce the total number of activation DCI or other activation signaling for activating SPS or CG when frequent BWP or CG switching is configured for a UE. In addition, the described techniques may reduce complexity for the UE since the UE may apply relatively fewer SPS or CG configurations during frequent BWP or CG switching. Additionally or alternatively, the techniques described herein may support enhanced coordination of scheduled transmissions between wireless devices and may increase the continuity and reliability for SPS or CG communications at the UE, since the UE may maintain ongoing SPS or CG communications without deactivating and reactivating multiple SPS or CG configurations during frequent BWP or CC switching.

Aspects of the disclosure are initially described in the context of wireless communications systems. Aspects of the disclosure are further illustrated by and described with reference to BWP and CC configurations, BWP switching configurations, BWP configuration sharing implementations, transmission configuration activation schemes, CC transmission configurations, a process flow, apparatus diagrams, system diagrams, and flowcharts that relate to CG and SPS for frequent BWP and CC switching.

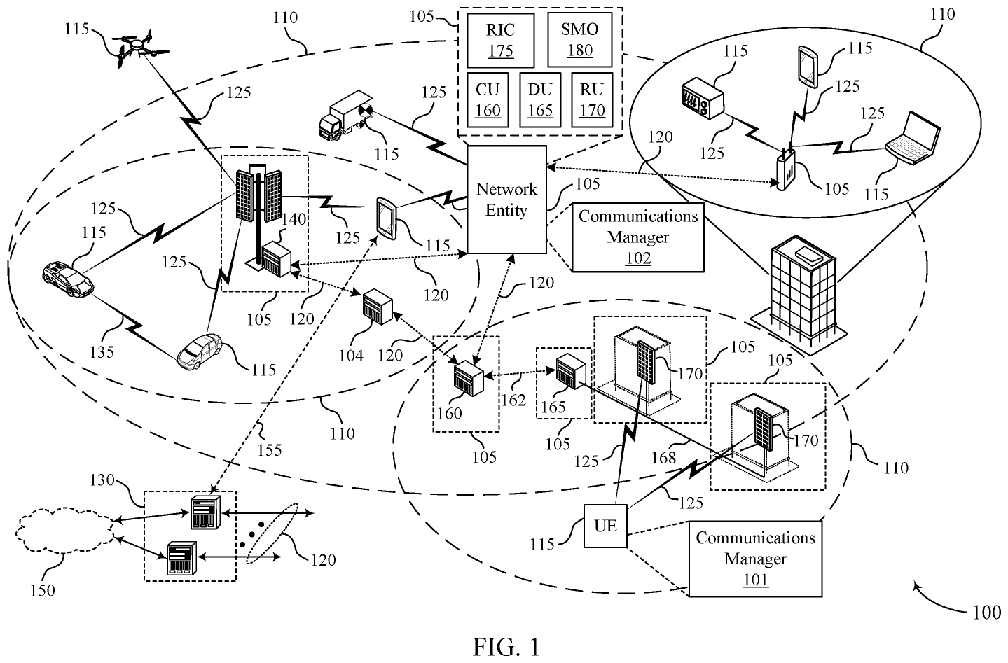

FIG. 1 illustrates an example of a wireless communications system 100 that supports CG and SPS for frequent BWP and CC switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature, and may include a network entity communications manager 102. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs) using UE communications manager 101.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a network entity also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CG and SPS for frequent BWP and CC switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications networks, a UE 115 and a network entity 105 may consume a certain amount of energy to communicate within a radio access network (RAN). For example, in a network entity energy consumption model, the total energy consumption may be based on a relative energy consumption for downlink and uplink transmissions, sleep states associated with the network entity 105, associated transition times of the sleep states, and one or more reference parameters or configurations. The total energy consumption may be further based on factors such as power added (PA) efficiency, number of transmission radio units (TxRUs), and the network entity load of a network entity 105. In this example, communications within a cellular network (e.g., a high traffic scenario) may be associated with a high cost of network energy consumption (e.g., 23% of total cost). The network energy consumption may be evaluated based on assessing network entity and UE communications (e.g., spectral efficiency, capacity, user perceived throughput (UPT), latency, handover performance, call drop rate, initial access performance, service level agreement (SLA) assurance related key performance indicator (KPIs), etc.), energy efficiency, and UE power consumption. For example, multiple KPIs may be evaluated for a network. In this case, performing communications within RAN uses a majority of the network energy consumption (e.g., running a 5G network uses up around 50% of the network energy). The high cost of network energy consumption associated with the RAN may result in increased latency in communications and may result in an inability to expand cellular networks.

In some examples, the UE 115 and the network entity 105 may implement network energy saving (NES) techniques in order to save power and maintain network operations. For example, the network entity 105 may enter different sleep states based on the current traffic level (or future predicted traffic levels) in a network. Transitioning from a light sleep state to a baseline state may take a relatively longer amount of time than transitioning from a deep sleep state to the baseline state.

Wireless communications system 100 may support various energy saving techniques by implementing dynamic switching between different communications configurations such as reference signaling configurations, antenna port configurations, transmission power configurations, and so on. To support dynamic switching between such configurations, the wireless communications system 100 may further support frequent switching between different BWPs, CCs, or both, each of which may be configured for different BWP or CC configurations. In some cases, however, frequent switching between different BWPs or CCs may introduce signaling interruption when switching occurs during an activated SPS or CG period that is ongoing within a BWP or a CC. For example, if a UE 115-a receives an activation DCI for SPS or CG while operating in a first BWP or CC, and then switches to a different BWP or CC, the ongoing activated SPS or CG communications may be dropped or otherwise interrupted or deactivated based on the switching.

To support efficient SPS or CG communications during frequent BWP or CC switching, and to improve overall network signaling overhead, the UE 115-a may receive a configuration for uplink CG or uplink SPS that configured for more than one BWP or CC. For example, the UE 115-a may receive a configuration that one or more BWPs or CCs for which an SPS or CG configuration is valid for. In such cases, the UE 115-a may receive a single activation DCI to activate the SPS or CG, and may can keep the activated SPS or CG configuration active across the multiple indicated BWPs or CCs.

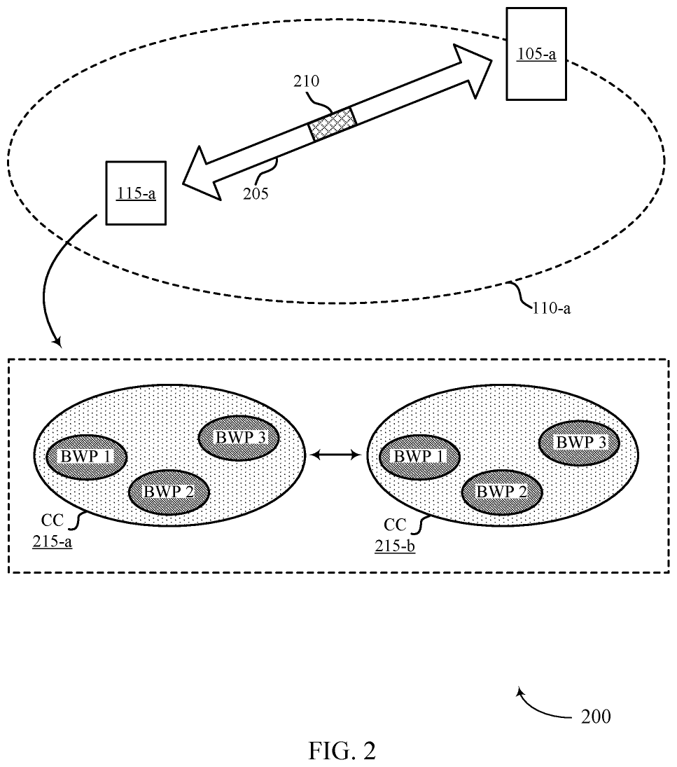

FIG. 2 illustrates an example of a wireless communications system 200 that supports CG and SPS for frequent BWP and CC switching in accordance with one or more aspects of the present disclosure. For example, wireless communications system may support SPS communications, CG communications, or both, between wireless devices such as a UE 115-a and a network entity 105-a, which may be examples of a UE 115 and a network entity 105 described with reference to FIG. 1. The network entity 105-a and the UE 115-a may communicate within a geographic coverage area 110-a and via a communication link 205.

The wireless communications system 200 may support relatively high frequency communications and advanced signaling techniques between the network entity 105-a and the UE 115-a. In order to reduce overall energy expenditure associated with such communications, the wireless communications system may implement various energy saving techniques. For example, some such energy saving techniques may include adapting various parameters and configuration changes to occur dynamically (e.g., without additional network signaling). For example, CSI-RS configurations, all related antenna port configurations, transmission power configurations, TRS configurations, BW configurations, and other configurations may be adapted to change dynamically.

To support such dynamic changes of signaling parameters, the wireless communications network may implement multiple BWPs and multiple CCs to dynamically change configurations via BWP or CC switching (e.g., dynamic BWP switching and dynamic CC switching). For example, each BWP or CC may be configured with a different set of configurations, and the UE 115-a may change between the different sets of configurations when switching between BWPs or CCs, or both.

In some cases however, frequent BWP switching between different BWPs or CCs may introduce signaling interruption when switching occurs during an activated SPS or CG period that is ongoing within a BWP or a CC. For example, if the UE 115-a receives an activation DCI for SPS or CG while operating in a first BWP or CC, and then switches to a different BWP or CC, the ongoing activated SPS or CG communications could be dropped or otherwise interrupted based on the switching.

To support SPS and CG communications for relatively frequent BWP or CC switching, a UE may receive a configuration 210 for uplink CG or uplink SPS that is tied to more than one BWP or CC. For example, the UE 115-a may receive a configuration 210 (e.g., via an RRC message or other control message) that indicates multiple BWPs (e.g., BWP 1, BWP 2, BWP 3) or CCs (e.g., CC 215-a, CC 215-b) to which the UE 115-a should apply a specific SPS or CG configuration. In such cases, the UE 115-a may receive a single activation DCI to activate the SPS or CG, and may not receive another activation DCI after switching to a different BWP or CC, but instead can keep the SPS or CG configuration active across the multiple indicated BWPs or CCs. In some examples, the SPS or CG configuration may be configured under the CC configuration for CC 215-a or for CC 215-b, or the SPS or CG configuration may be configured under one of the BWP configurations for BWP 1, BWP 2, or BWP 3. In some other examples, the SPS or CG configuration may be partially shared between CCs or BWPs.

Such dynamic configuration of SPS, CG, or both, across multiple different BWPs or CCs may improve overall network signaling overhead and network power expenditure. Additionally or alternatively, the techniques described herein may support enhanced coordination of scheduled transmissions between wireless devices and may increase the efficiency for SPS or CG communications at the UE 115-a, since the UE 115-a may maintain ongoing SPS or CG communications without deactivating and reactivating multiple SPS or CG configurations during frequent BWP or CC switching.

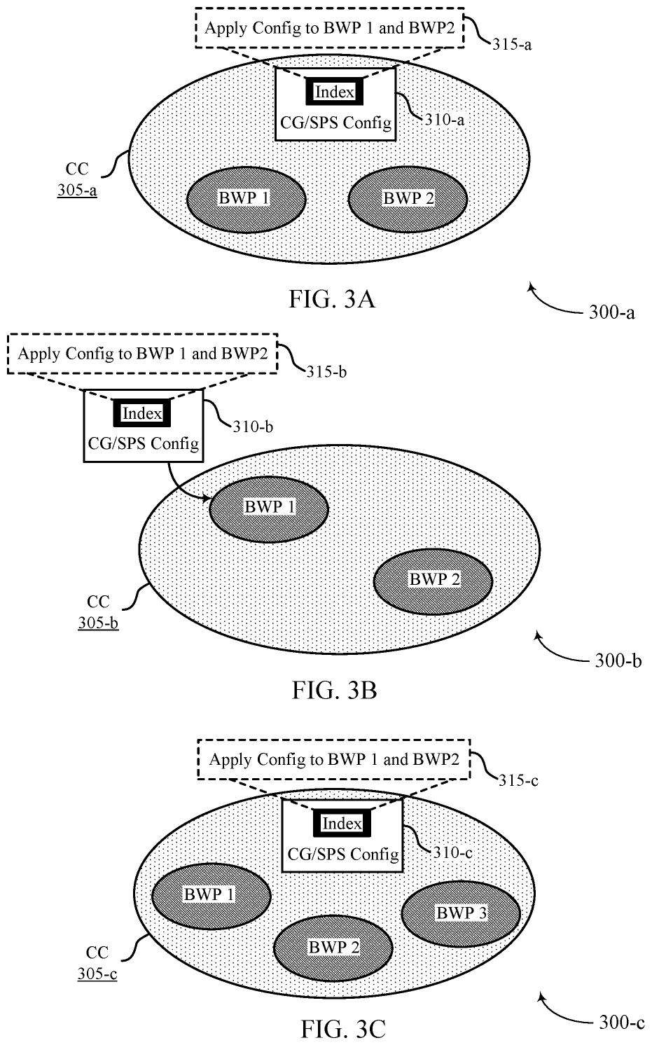

FIGS. 3A-3C illustrate example BWP and CC configurations 300-a, 300-b, and 300-c that support CG and SPS for frequent BWP and CC switching in accordance with one or more aspects of the present disclosure. For example, a UE (such as a UE 115 described with reference to FIGS. 1 and 2) may be support communications using a CC 305-a, 305-b, or 305-c, and may be configured with one or more BWPs (e.g., BWP 1, BWP 2, BWP 3, or a combination thereof), which may dynamically adapt the carrier bandwidth and numerology in which the UE operates. Additionally or alternatively, the BWP 1, BWP 2, BWP 3, and the CC may be associated with different communications configurations, which the UE may have the capability to switch between. In some examples, the UE may support transmission configurations such as uplink SPS and uplink CG that are associated or linked to more than one BWP.

FIG. 3A illustrates BWP and CC configuration 300-a, in which the UE may be configured with an uplink SPS or uplink CG configuration 310-a under the cell configuration for CC 305-a. This uplink SPS or uplink CG configuration 310-a may include an index 315-a which indicates all the BWP under which this configuration is valid (e.g., the index 315-a should may indicate whether the SPS configuration is valid for BWP 1, BWP 2, or both). As an example, the index 315-a indicates that the SPS configuration is to be applied for both BWP 1 and BWP 2.

FIG. 3B illustrates BWP and CC configuration 300-b, in which the UE may be configured with an uplink SPS or uplink CG configuration 310-b under a BWP configuration, such as the BWP configuration for BWP 1 in CC 305-b. For example, the SPS or uplink CG configuration 310-b may associated with BWP 1, and may include an index 315-b which indicates that the SPS configuration is also valid for BWP 2. In such examples, the SPS or uplink CG configuration 310-b for BWP 1 is associated with (or otherwise configured for) both BWP 1 and BWP 2.

FIG. 3C illustrates BWP and CC configuration 300-c, in which the UE may be configured with an uplink SPS or uplink CG configuration 310-c under the cell configuration for CC 305-c. This uplink SPS or uplink CG configuration 310-c may include an index 315-c which indicates all the BWP under which this configuration is valid (e.g., the index 315-c should may indicate whether the SPS configuration is valid for BWP 1, BWP 2, BWP 3 or any combination thereof). As an example, the index 315-c indicates that the uplink SPS or uplink CG configuration 310-c is to be applied for both BWP 1 and BWP 2, but a different SPS configuration is to be applied for BWP 3. For example, the index 315-c may indicate that the uplink SPS or uplink CG configuration 310-c may apply to BWP 1 and BWP2 but may not be applied to BWP 3. In such examples, when switching between BWPs, the UE may keep uplink SPS or uplink CG configuration 310-c activated for BWP 1 and BWP 2, but would activate a different SPS or CG configuration when switching to BWP 3.

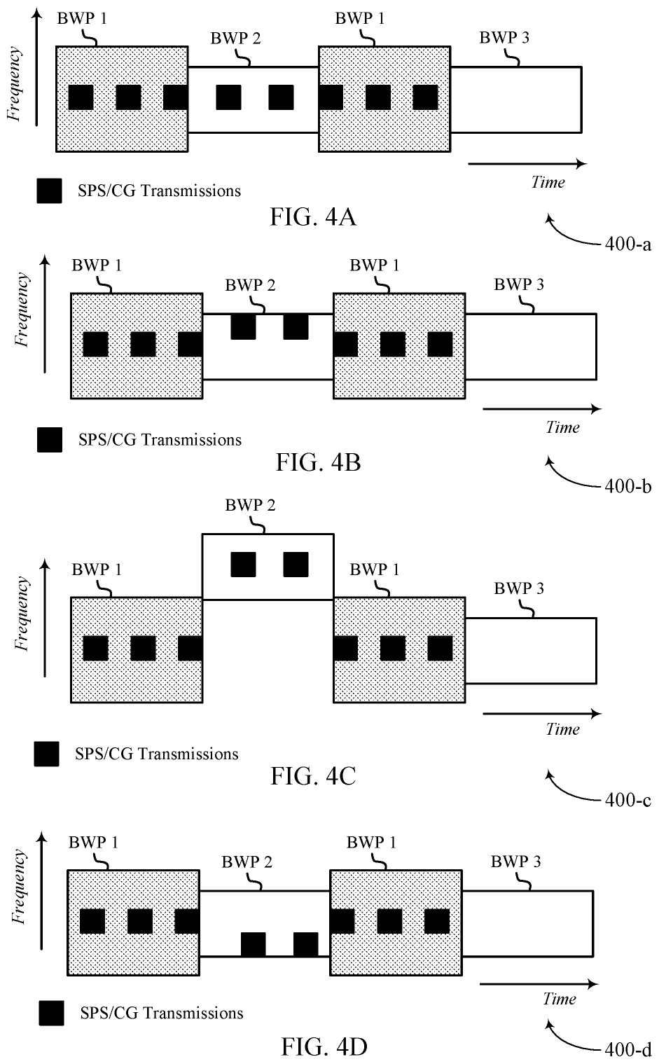

FIGS. 4A-4D illustrate an example of BWP switching configurations 400-a, 400-b, 400-c, and 400-d that support CG and SPS for frequent BWP and CC switching in accordance with one or more aspects of the present disclosure. For example, a UE (such as a UE 115 described with reference to FIGS. 1 and 2) may switch between active BWPs based on a switch command received in dedicated RRC signaling, DCI, a configured BWP timer, or MAC-CE. In some examples, each BWP (e.g., BWP 1, BWP 2, and BWP 3) may be associated with an uplink SPS or CG configuration.

In some examples, a UE may receive a control message that indicates a configuration that links one or more uplink SPS or CG configurations between BWPs. For example, the configuration may link the configuration between BWP 1 and BWP 2 such that when the UE switches between BWP 1 and BWP 2 and back to BWP 1, the UE may maintain ongoing SPS or CG communications without deactivating or receiving a separate activation DCI when switching between BWPs. For example, for BWPs that participate in the same UL-CG or SPS configuration, the UE may not deactivate the already activated SPS or CG transmissions based on the linked SPS or CG configuration.

FIG. 4A illustrates BWP switching configuration 400-a, in which the UE may support BWP switching between BWP 1, BWP 2, and BWP 3. In such cases, the BWP 1, BWP 2, and BWP 3 may be aligned in frequency. The UE may receive a control message that indicates a linkage or an association between the SPS or CG configurations configured for BWP 1 and BWP 2. The UE may transmit the SPS or CG transmissions in BWP 1 in accordance with the activated SPS or CG configuration, then may switch to BWP 2 to continue transmitting the SPS or CG transmissions. In such cases, the UE may not receive a separate activation DCI to continue transmissions in BWP 2 after switching from BWP 1. The UE may then switch back to BWP 1 and may continue to transmit the SPS or CG transmissions based on the linked SPS or CG configuration between BWP 1 and BWP 2.

FIG. 4B illustrates BWP switching configuration 400-b, in which the UE may support BWP switching between BWP 1, BWP 2, and BWP 3. In such cases, the BWP 1, BWP 2, and BWP 3 may be aligned in frequency, but the SPS or CG transmissions may be misaligned in frequency between BWP 1 and BWP 2. The UE may receive a control message that indicates a linkage or an association between the SPS or CG configurations configured for BWP 1 and BWP 2, and may transmit the SPS or CG transmissions in BWP 1 in accordance with the activated SPS or CG configuration, then may switch to BWP 2 to continue transmitting the SPS or CG transmissions.

FIG. 4C illustrates BWP switching configuration 400-c, in which the UE may support BWP switching between BWP 1, BWP 2, and BWP 3. In such cases, the BWP 1, BWP 2, and BWP 3 may be misaligned in frequency, and the SPS or CG transmissions may also be misaligned in frequency between BWP 1 and BWP 2. The UE may receive a control message that indicates a linkage or an association between the SPS or CG configurations configured for BWP 1 and BWP 2, and may transmit the SPS or CG transmissions in BWP 1 in accordance with the activated SPS or CG configuration, then may switch to BWP 2 to continue transmitting the SPS or CG transmissions.

FIG. 4D illustrates BWP switching configuration 400-d, in which the UE may support BWP switching between BWP 1, BWP 2, and BWP 3. In such cases, the BWP 1, BWP 2, and BWP 3 may be aligned in frequency, and the SPS or CG transmissions may be misaligned in frequency and time between BWP 1 and BWP 2. The UE may receive a control message that indicates a linkage or an association between the SPS or CG configurations configured for BWP 1 and BWP 2, and may transmit the SPS or CG transmissions in BWP 1 in accordance with the activated SPS or CG configuration, then may switch to BWP 2 to continue transmitting the SPS or CG transmissions.

By configuring a linkage between the SPS or CG configurations for BWPs in a BWP switching configuration, the network may reduce the amount of activation signaling transmitted to UEs. For example, the UE may receive a single activation DCI for an SPS configuration that is valid for multiple BWPs, such that the UE maintains an active SPS or CG configuration across the multiple BWPs without deactivating to switch between BWPs.

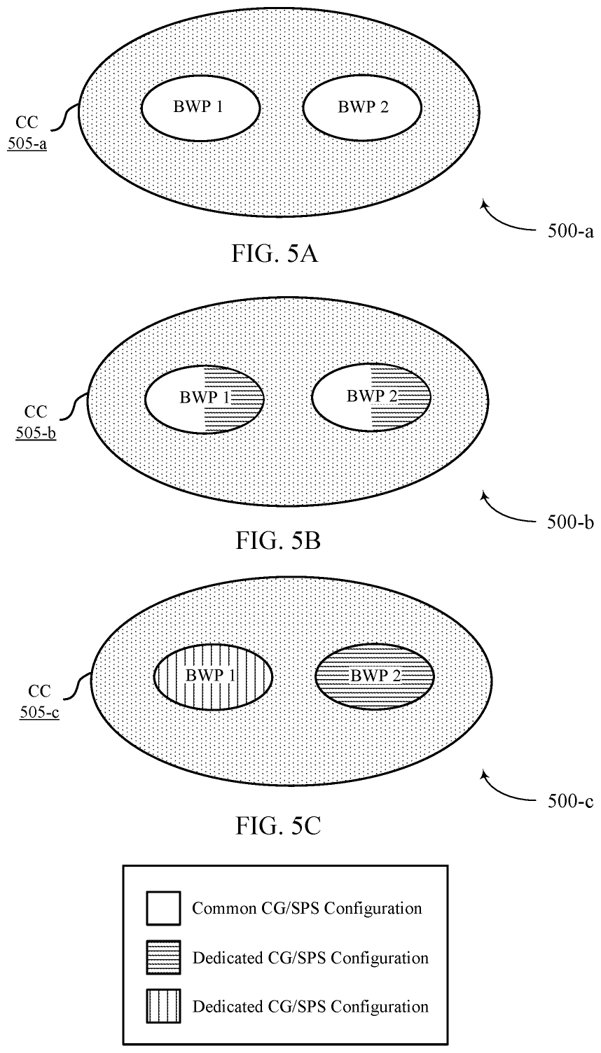

FIGS. 5A-5C illustrate an example of BWP configuration sharing implementations 500-a, 500-b, and 500-c that support CG and SPS for frequent BWP and CC switching in accordance with one or more aspects of the present disclosure. For example, a UE (such as a UE 115 described with reference to FIGS. 1 and 2) may be support communications using a CC 505-a, 505-b, or 505-c, and may be configured with one or more BWPs (e.g., BWP 1, BWP 2, or both), which may dynamically adapt the carrier bandwidth and numerology in which the UE operates. Additionally or alternatively, the BWP 1, the BWP 2, and the CC may be associated with different communications configurations, which the UE may be capable of switching between. In some examples, the UE may support transmission configurations such as uplink SPS and uplink CG that are associated or linked to more than one BWP.

In some examples, a CC or a BWP may support one or more uplink CG or SPS configurations, which may indicate a configuration for transmitting uplink CG or SPS and may also include various parameters such as time-domain allocation parameters, frequency domain allocation parameters, MCS parameters, and periodicity parameters. In some examples, the uplink CG or SPS configuration may be RRC configured.

FIG. 5A illustrates BWP configuration sharing implementation 500-a, where the uplink CG or SPS configuration may be the same across the participating BWPs (e.g., BWP 1 and BWP 2) for the CC 505-a. In some examples, the CG or SPS configuration may be a common CG or SPS configuration.

FIG. 5B illustrates BWP configuration sharing implementation 500-b, where the uplink CG or SPS configuration may be shared across BWP 1 and BWP 2, or a subset of the SPS configurations may be shared across BWP 1 and BWP 2 for the CC 505-b. In such implementations, at least a portion of the CG or SPS configuration is common and at least a portion of the CG or SPS configurations are dedicated.

FIG. 5C illustrates BWP configuration sharing implementation 500-c, where the uplink CG or SPS configuration may be separate or different for BWP 1 and BWP 2, such that each configuration is specific to BWP 1 and BWP 2 for the CC 505-c. In such implementations, BWP 1 may have a first dedicated CG or SPS configuration and BWP 2 may have a second dedicated CG or SPS configuration.

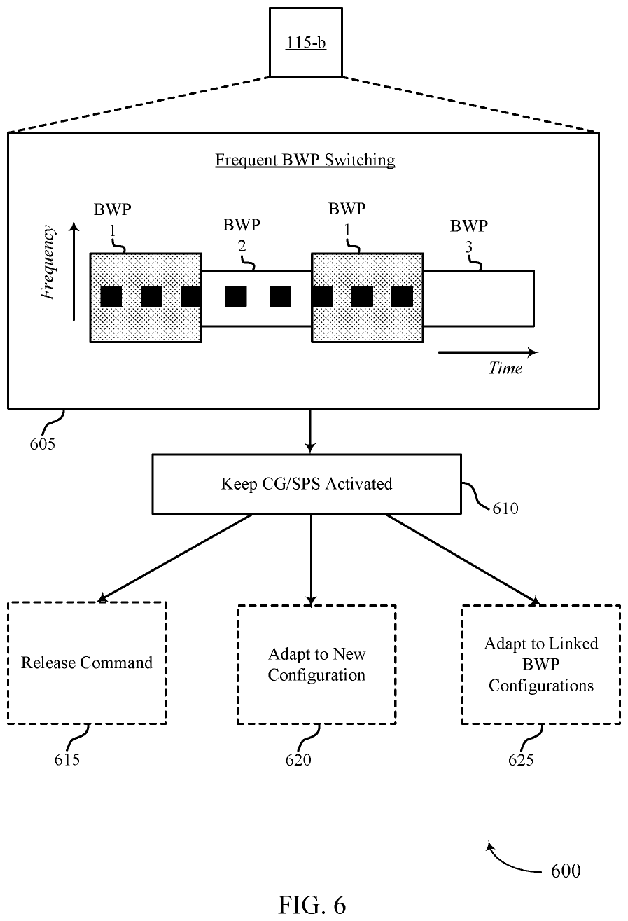

FIG. 6 illustrates an example of a transmission configuration activation scheme 600 that supports CG and SPS for frequent BWP and CC switching in accordance with one or more aspects of the present disclosure. For example, a UE 115-b (which may be an example of a UE 115 described with reference to FIGS. 1 and 2) may be configured with frequent BWP switching based on a switch command received in dedicated RRC signaling. In some examples, each BWP (e.g., BWP 1, BWP 2, and BWP 3) may be associated with an uplink SPS or CG configuration. In some examples, a UE may receive a control message that indicates a configuration that links one or more uplink SPS or CG configurations between BWPs.

In some examples where the UE 115-b is configured for frequent BWP switching 605, the UE 115-b may keep the activated SPS or CG configuration activated at 610 until the reception of a deactivation command or a release command 615. In some other examples, at 620 the UE 115-b may keep the SPS or CG (of a first BWP) activated while adapting to the dedicated configuration of a new BWP that the UE switches to. For example, if the UE 115-b switches BWP 1 to BWP 2 (where BWP1 and BWP2 have different SPS or CG configurations) the UE 115-b may adapt to the different SPS or CG configuration in BWP 2. In some other examples, SPS or CG configurations in different BWPs may be linked together at 625 such that if a first SPS configuration (e.g., SPS1) is active for a first BWP (e.g., BWP1) and is linked to a third SPS configuration (e.g., SPS3) in a second BWP (e.g., BWP2), the UE 115-b may assume implicit activation of the third SPS configuration.

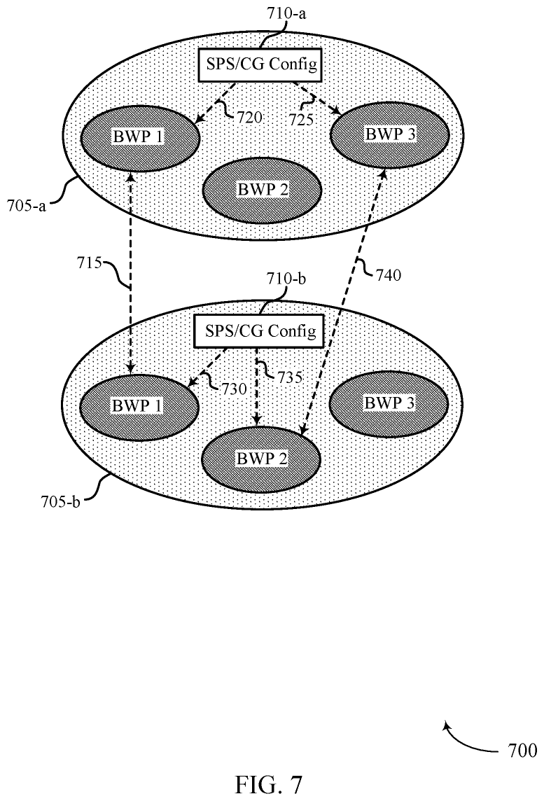

FIG. 7 illustrates an example of a CC transmission configuration 700 that supports CG and SPS for frequent BWP and CC switching in accordance with one or more aspects of the present disclosure. For example, a UE (such as a UE 115 described with reference to FIGS. 1 and 2) may be support communications using CC 705-a, a 705-b, or both, and may be configured with one or more BWPs (e.g., BWP 1, BWP 2, BWP 3, or a combination thereof), which may dynamically adapt the carrier bandwidth and numerology in which the UE operates. Additionally or alternatively, the BWP 1, BWP 2, BWP 3, and the CCs may be associated with different communications configurations, which the UE may be capable of switching between. In some examples, the UE may support transmission configurations such as uplink SPS and uplink CG that are associated or linked to more than one BWP or liked across more than one CC.

In some examples, the UE may be configured with more than one CC that are at least partially overlapping in the frequency domain, or the UE may be configured with more than one CC that are non-overlapping in the frequency domain. In such examples, the UE may be configured with an SPS or CG configuration that are associated with more than one CC. Additionally or alternatively, the UE may be configured with multiple SPS or CG configurations in different CCs that are linked together.

In some examples, the SPS or CG configuration 710-a and the SPS or CG configuration 710-b configured for BWP 1, BWP2, and BWP 3 may be linked across CC 705-a and 705-b. In such cases, if the network switches CCs, the UE may maintain the SPS or CG configurations before and after switching CCs. In some examples, the SPS or CG configuration 710-a may be associated with the BWP 1 (at 720) and the BWP 3 (at 725) in CC 705-a. The SPS or CG configuration 710-b may be associated with the BWP 1 (at 730) and the BWP 3 (at 735) in CC 705-b. The BWP 1 of CC 705-a may be linked to BWP 1 of the CC 705-b (at 715) which may indicate a shared or linked SPS or CG configuration (e.g., SPS or CG configuration 710-a may be linked to SPS or CG configuration 710-b) via the linkage 715. In addition, the BWP 3 of CC 705-a may be linked to BWP 2 of the CC 705-b (at 740) which may indicate a shared or linked SPS or CG configuration (e.g., SPS or CG configuration 710-a may be linked to SPS or CG configuration 710-b) via the linkage 740.

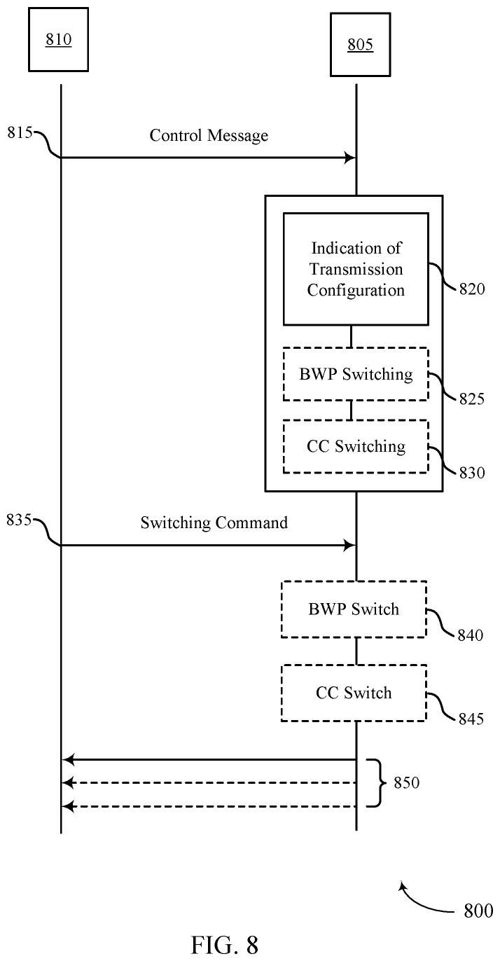

FIG. 8 illustrates an example of a process flow 800 that supports CG and SPS for frequent BWP and CC switching in accordance with one or more aspects of the present disclosure. In some examples, process flow 800 may implement aspects of wireless communications system 100. The process flow 800 may include communications devices 805 and 810 which may each be an example of a UE 115 or a network entity 105 as described herein. Alternative examples of the following process flow may be implemented, where some steps are performed in a different order than described or are not performed at all. In some cases, steps may include additional features not mentioned below, or further steps may be added.

At 815, the communications device 810 may transmit, and the communications device 805 may receive, a control message that indicates at least one transmission configuration 820 to apply for BWP switching 825 between multiple BWPs, to apply for CC switching 830 between multiple CCs, or both, the at least one transmission configuration (e.g., a CG or SPS configuration) associated with a set of scheduled transmissions (e.g., CG or SPS transmissions). In some examples, the at least one transmission configuration indicates a linkage between the multiple BWPs, the multiple CCs, or both, and includes an index that identifies each BWP of the multiple BWPs or each CC of the multiple CCs to which the at least one transmission configuration applies. In some other examples, the at least one transmission configuration 820 includes one or more time domain allocation parameters, one or more frequency domain allocation parameters, one or more MCS parameters, one or more periodicity parameters, or any combination thereof.

In some examples, the at least one transmission configuration 820 may be a single transmission configuration for the first BWP and the second BWP, the first CC and the second CC, or both. In some other examples, the at least one transmission configuration 820 may include a common transmission configuration for the first BWP and the second BWP, a first dedicated transmission configuration for the first BWP, and a second dedicated transmission configuration for the second BWP, In some other examples, the at least one transmission configuration 820 may include a common transmission configuration for the first CC and the second CC, a first dedicated transmission configuration for the first CC, and a second dedicated transmission configuration for the second CC. In some other examples, the at least one transmission configuration 820 may include a first transmission configuration for the first BWP and a second transmission configuration for the second BWP, a first transmission configuration for the first CC and a second transmission configuration for the second CC, or both.

At 835, the communications device 805 may receive a switch command from the communications device 810, which instructs the communications device 805 to switch from a first BWP to a second BWP at 840, from a first CC to a second CC at 845, or both. In some examples, the multiple CCs at least partially overlap in a frequency domain or are non-overlapping in the frequency domain.

At 850, the communications device 805 may transmit one or more scheduled transmissions of the set of scheduled transmissions in accordance with the at least one transmission configuration. In some examples, the at least one transmission configuration indicates an activation of the one or more scheduled transmissions in the second BWP, in the second CC, or both, and the communications device 805 may transmit the one or more scheduled transmissions based on the activation.

In some examples, the at least one transmission configuration 820 may indicate an activation of the one or more scheduled transmissions in the second BWP, the second CC, or both, until reception of a deactivation command or a release command. The communications device 805 may receive the deactivation command or the release command and may deactivate at least one of the one or more scheduled transmissions in accordance with the release command, the deactivation command, or both. In some other examples, the at least one transmission configuration 820 may indicate an activation of the one or more scheduled transmissions in the second BWP, the second CC, or both, for a defined time period after receipt of the switch command. Then, the communications device 805 may communicate, via the second BWP, the second CC, or both, a scheduled transmission of the one or more scheduled transmissions using a second configuration of the at least one transmission configuration for the second BWP, the second CC, or both, after the defined time period.

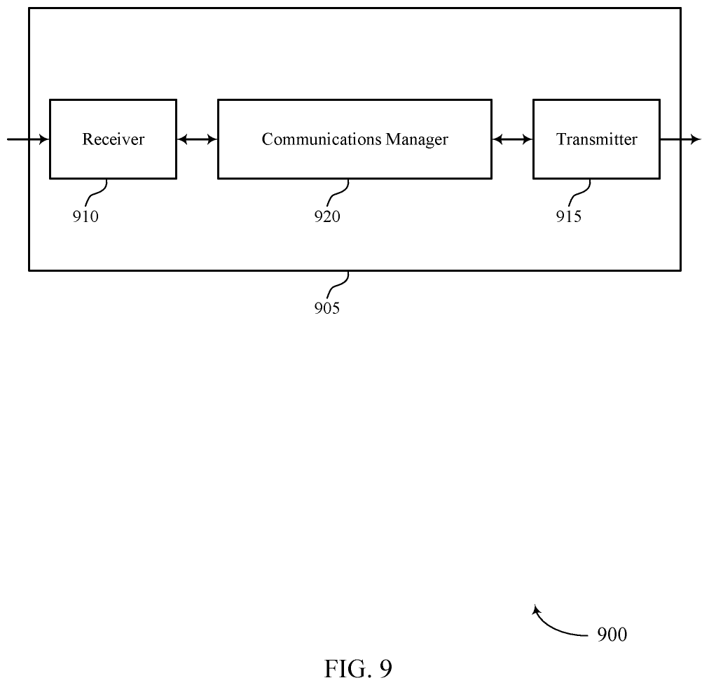

FIG. 9 shows a diagram 900 of a device 905 that supports CG and SPS for frequent BWP and CC switching in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to CG and SPS for frequent BWP and CC switching). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to CG and SPS for frequent BWP and CC switching). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of CG and SPS for frequent BWP and CC switching as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. For example, the communications manager 920 may be configured as or otherwise support a means for receiving a control message that indicates at least one transmission configuration to apply for BWP switching between multiple BWPs, to apply for CC switching between multiple CCs, or both, the at least one transmission configuration associated with a set of multiple scheduled transmissions. The communications manager 920 may be configured as or otherwise support a means for receiving a switch command to switch from a first BWP to a second BWP, from a first CC to a second CC, or both. The communications manager 920 may be configured as or otherwise support a means for transmitting one or more scheduled transmissions of the set of multiple scheduled transmissions in accordance with the at least one transmission configuration.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing based on reduced activation signaling, reduced power consumption and improved network signaling overhead.

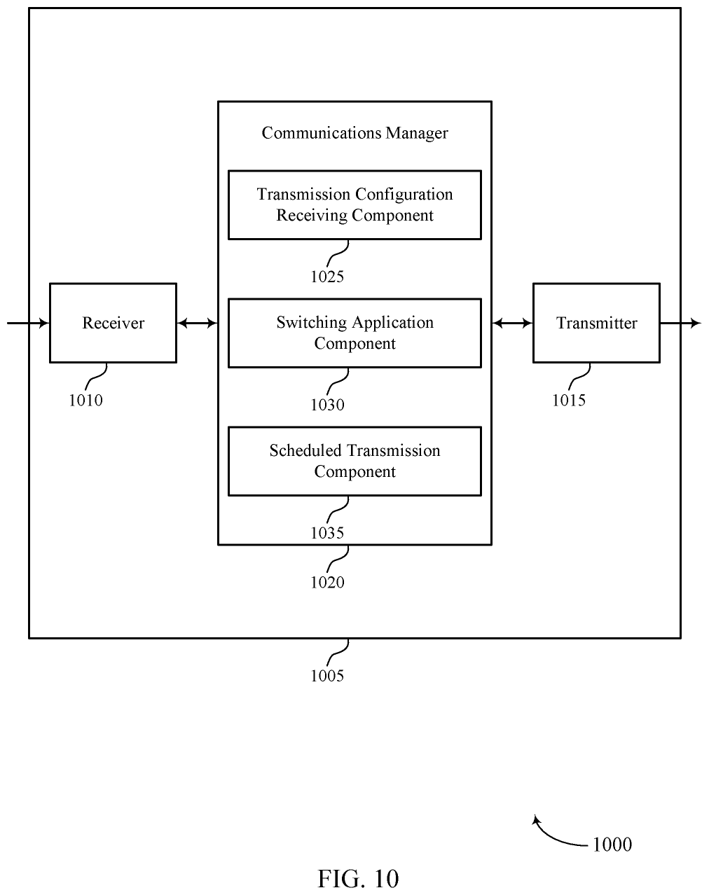

FIG. 10 shows a diagram 1000 of a device 1005 that supports CG and SPS for frequent BWP and CC switching in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to CG and SPS for frequent BWP and CC switching). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to CG and SPS for frequent BWP and CC switching). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of CG and SPS for frequent BWP and CC switching as described herein. For example, the communications manager 1020 may include a transmission configuration receiving component 1025, a switching application component 1030, a scheduled transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The transmission configuration receiving component 1025 may be configured as or otherwise support a means for receiving a control message that indicates at least one transmission configuration to apply for BWP switching between multiple BWPs, to apply for CC switching between multiple CCs, or both, the at least one transmission configuration associated with a set of multiple scheduled transmissions. The switching application component 1030 may be configured as or otherwise support a means for receiving a switch command to switch from a first BWP to a second BWP, from a first CC to a second CC, or both. The scheduled transmission component 1035 may be configured as or otherwise support a means for transmitting one or more scheduled transmissions of the set of multiple scheduled transmissions in accordance with the at least one transmission configuration.

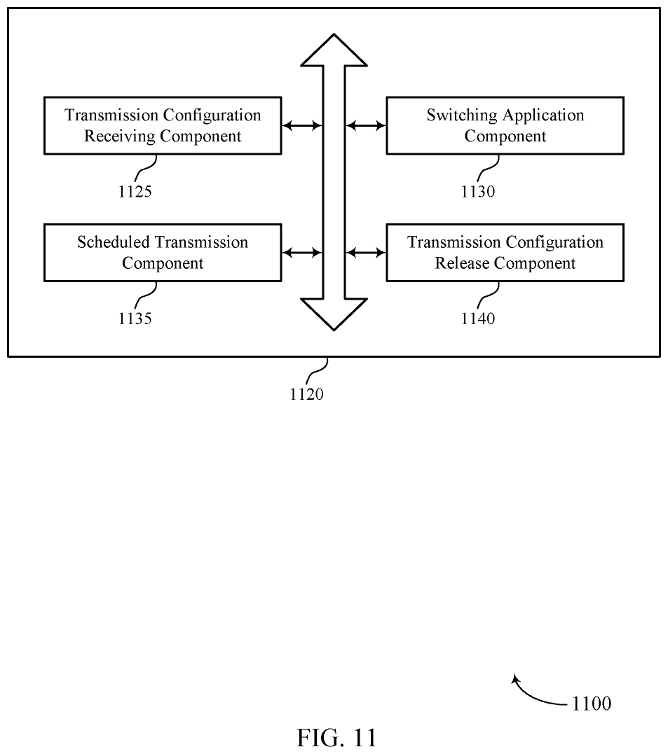

FIG. 11 shows a diagram 1100 of a communications manager 1120 that supports CG and SPS for frequent BWP and CC switching in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of CG and SPS for frequent BWP and CC switching as described herein. For example, the communications manager 1120 may include a transmission configuration receiving component 1125, a switching application component 1130, a scheduled transmission component 1135, a transmission configuration release component 1140, or any combination thereof. Each of these components may communicate, directly or indirectly, with one another (e.g., via one or more buses).

The communications manager 1120 may support wireless communication at a UE in accordance with examples as disclosed herein. The transmission configuration receiving component 1125 may be configured as or otherwise support a means for receiving a control message that indicates at least one transmission configuration to apply for BWP switching between multiple BWPs, to apply for CC switching between multiple CCs, or both, the at least one transmission configuration associated with a set of multiple scheduled transmissions. The switching application component 1130 may be configured as or otherwise support a means for receiving a switch command to switch from a first BWP to a second BWP, from a first CC to a second CC, or both. The scheduled transmission component 1135 may be configured as or otherwise support a means for transmitting one or more scheduled transmissions of the set of multiple scheduled transmissions in accordance with the at least one transmission configuration.

In some examples, the at least one transmission configuration includes an uplink CG configuration, a SPS configuration, or both.

In some examples, the control message further includes an index that identifies each BWP of the multiple BWPs or each CC of the multiple CCs to which the at least one transmission configuration applies.

In some examples, the at least one transmission configuration indicates an activation of the one or more scheduled transmissions in the second BWP, and the scheduled transmission component 1135 may be configured as or otherwise support a means for transmitting the one or more scheduled transmissions of the set of multiple scheduled transmissions in the second BWP, in the second CC, or both, based on the activation.

In some examples, the at least one transmission configuration includes a single transmission configuration for the first BWP and the second BWP, the first CC and the second CC, or both.

In some examples, the at least one transmission configuration includes a common transmission configuration for the first BWP and the second BWP, a first dedicated transmission configuration for the first BWP, and a second dedicated transmission configuration for the second BWP.

In some examples, the at least one transmission configuration includes a common transmission configuration for the first CC and the second CC, a first dedicated transmission configuration for the first CC, and a second dedicated transmission configuration for the second CC.

In some examples, the at least one transmission configuration includes a first transmission configuration for the first BWP and a second transmission configuration for the second BWP, a first transmission configuration for the first CC and a second transmission configuration for the second CC, or both.

In some examples, the at least one transmission configuration indicates an activation of the one or more scheduled transmissions in the second BWP, and the transmission configuration release component 1140 may be configured as or otherwise support a means for receiving the release command, the deactivation command, or both, that indicates a release or deactivation of the one or more scheduled transmissions in the second BWP, the second CC, or both. In some examples, the at least one transmission configuration indicates an activation of the one or more scheduled transmissions in the second BWP, and the transmission configuration release component 1140 may be configured as or otherwise support a means for deactivating at least one of the one or more scheduled transmissions in accordance with the release command, the deactivation command, or both.

In some examples, the at least one transmission configuration indicates activation of the one or more scheduled transmissions in the second BWP, and the scheduled transmission component 1135 may be configured as or otherwise support a means for communicating, via the second BWP, the second CC, or both, a scheduled transmission of the one or more scheduled transmissions using a second configuration of the at least one transmission configuration for the second BWP, the second CC, or both, after the defined time period.

In some examples, the multiple CCs include one or more CCs that at least partially overlap in a frequency domain or are non-overlapping in the frequency domain.

In some examples, the at least one transmission configuration is indicative of a linkage between the multiple BWPs, the multiple CCs, or both.

In some examples, the at least one transmission configuration includes one or more time domain allocation parameters, one or more frequency domain allocation parameters, one or more modulation and coding scheme parameters, one or more periodicity parameters, or any combination thereof. In some examples, the control message includes an RRC message.

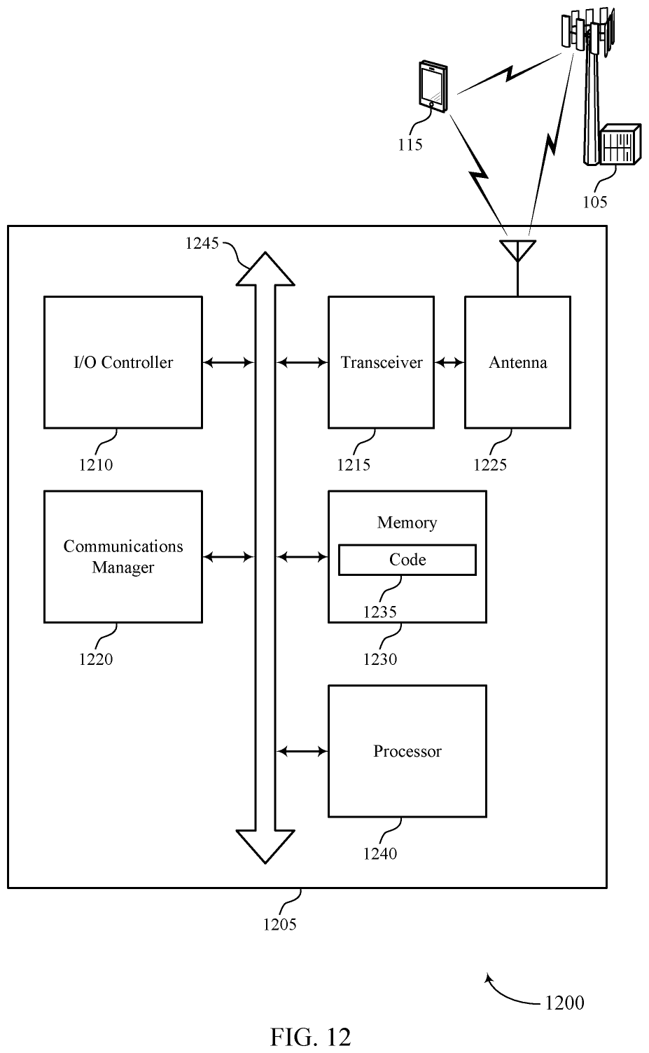

FIG. 12 shows a diagram of a system 1200 including a device 1205 that supports CG and SPS for frequent BWP and CC switching in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting CG and SPS for frequent BWP and CC switching). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for receiving a control message that indicates at least one transmission configuration to apply for BWP switching between multiple BWPs, to apply for CC switching between multiple CCs, or both, the at least one transmission configuration associated with a set of multiple scheduled transmissions. The communications manager 1220 may be configured as or otherwise support a means for receiving a switch command to switch from a first BWP to a second BWP, from a first CC to a second CC, or both. The communications manager 1220 may be configured as or otherwise support a means for transmitting one or more scheduled transmissions of the set of multiple scheduled transmissions in accordance with the at least one transmission configuration.

By including or configuring the communications manager 1220 in accordance with examples as described herein, the device 1205 may support techniques for improved communication reliability for SPS and CG communications during frequent BWP or CC switching, reduced latency based on reduced activation signaling, reduced power consumption from the network and UE perspective based on improved signaling overhead, improved coordination between devices, and longer battery life.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of CG and SPS for frequent BWP and CC switching as described herein, or the processor 1240 and the memory 1230 may be otherwise configured to perform or support such operations.

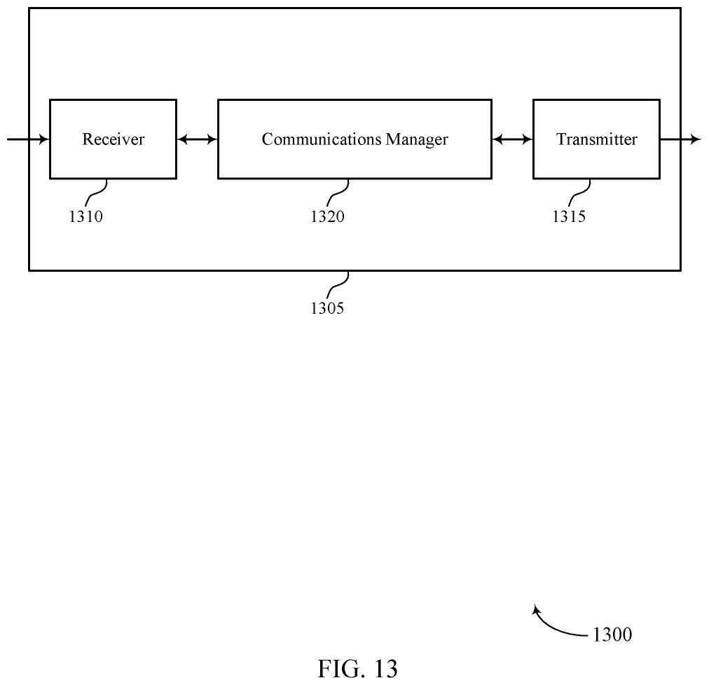

FIG. 13 shows a diagram 1300 of a device 1305 that supports CG and SPS for frequent BWP and CC switching in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of CG and SPS for frequent BWP and CC switching as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. For example, the communications manager 1320 may be configured as or otherwise support a means for outputting a control message that indicates at least one transmission configuration for BWP switching between multiple BWPs, for CC switching between multiple CCs, or both, the at least one transmission configuration associated with a set of multiple scheduled transmissions at a UE. The communications manager 1320 may be configured as or otherwise support a means for outputting a switch command to switch from a first BWP to a second BWP, from a first CC to a second CC, or both. The communications manager 1320 may be configured as or otherwise support a means for obtaining one or more scheduled transmissions of the set of multiple scheduled transmissions in accordance with the at least one transmission configuration.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing based on reduced activation signaling, reduced power consumption and improved network signaling overhead.

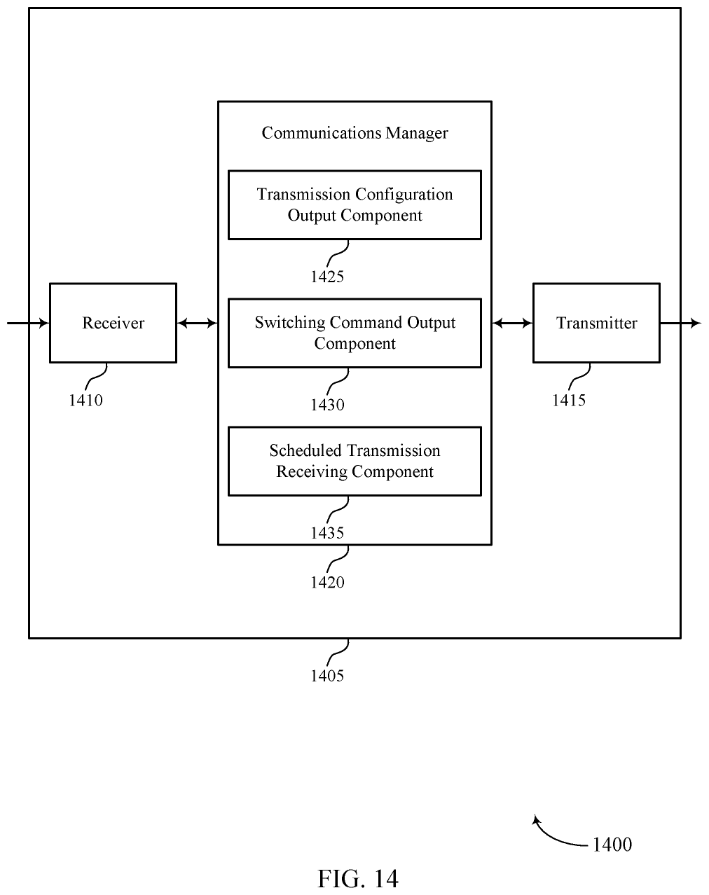

FIG. 14 shows a diagram 1400 of a device 1405 that supports CG and SPS for frequent BWP and CC switching in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of CG and SPS for frequent BWP and CC switching as described herein. For example, the communications manager 1420 may include a transmission configuration output component 1425, a switch command output component 1430, a scheduled transmission receiving component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. The transmission configuration output component 1425 may be configured as or otherwise support a means for outputting a control message that indicates at least one transmission configuration for BWP switching between multiple BWPs, for CC switching between multiple CCs, or both, the at least one transmission configuration associated with a set of multiple scheduled transmissions at a UE. The switch command output component 1430 may be configured as or otherwise support a means for outputting a switch command to switch from a first BWP to a second BWP, from a first CC to a second CC, or both. The scheduled transmission receiving component 1435 may be configured as or otherwise support a means for obtaining one or more scheduled transmissions of the set of multiple scheduled transmissions in accordance with the at least one transmission configuration.

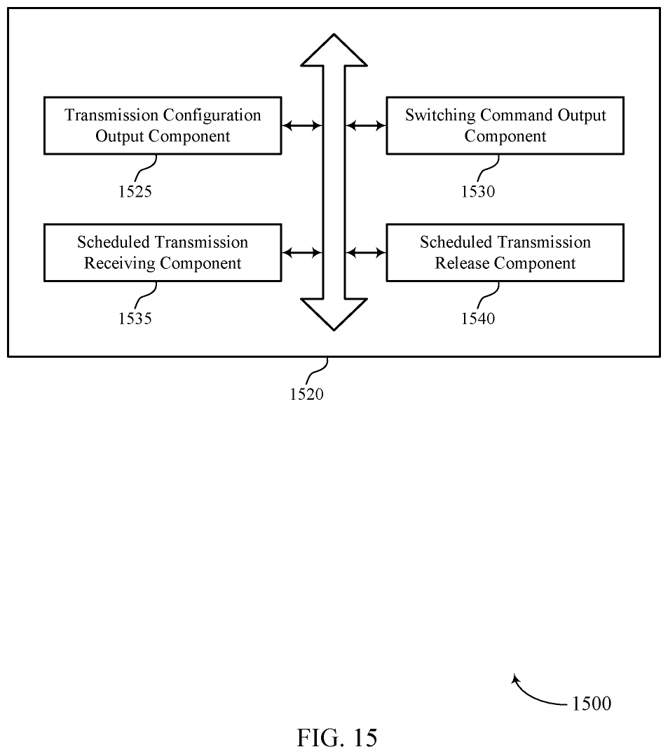

FIG. 15 shows a diagram 1500 of a communications manager 1520 that supports CG and SPS for frequent BWP and CC switching in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of CG and SPS for frequent BWP and CC switching as described herein. For example, the communications manager 1520 may include a transmission configuration output component 1525, a switch command output component 1530, a scheduled transmission receiving component 1535, a scheduled transmission release component 1540, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The transmission configuration output component 1525 may be configured as or otherwise support a means for outputting a control message that indicates at least one transmission configuration for BWP switching between multiple BWPs, for CC switching between multiple CCs, or both, the at least one transmission configuration associated with a set of multiple scheduled transmissions at a UE. The switch command output component 1530 may be configured as or otherwise support a means for outputting a switch command to switch from a first BWP to a second BWP, from a first CC to a second CC, or both. The scheduled transmission receiving component 1535 may be configured as or otherwise support a means for obtaining one or more scheduled transmissions of the set of multiple scheduled transmissions in accordance with the at least one transmission configuration.

In some examples, the at least one transmission configuration includes an uplink CG configuration, a SPS configuration, or both.

In some examples, the control message further includes an index that identifies each BWP of the multiple BWPs or each CC of the multiple CCs to which the at least one transmission configuration applies.

In some examples, the at least one transmission configuration indicates an activation of the one or more scheduled transmissions in the second BWP, and the scheduled transmission receiving component 1535 may be configured as or otherwise support a means for obtaining the one or more scheduled transmissions of the set of multiple scheduled transmissions in the second BWP, in the second CC, or both, based on the activation.

In some examples, the at least one transmission configuration includes a single transmission configuration to apply for the first BWP and the second BWP, the first CC and the second CC, or both.

In some examples, the at least one transmission configuration includes a common transmission configuration to apply for the first BWP and the second BWP, and further indicates a first dedicated transmission configuration for the first BWP and a second dedicated transmission configuration for the second BWP.

In some examples, the at least one transmission configuration includes a common transmission configuration for the first CC and the second CC, and a first dedicated transmission configuration for the first CC and a second dedicated transmission configuration for the second CC.

In some examples, the at least one transmission configuration includes a first transmission configuration for the first BWP and a second transmission configuration for the second BWP, a first transmission configuration for the first CC and a second transmission configuration for the second CC, or both.

In some examples, the at least one transmission configuration indicates an activation of the one or more scheduled transmissions in the second BWP, and the scheduled transmission release component 1540 may be configured as or otherwise support a means for outputting the release command, the deactivation command, or both, that indicates a release or deactivation of at least one of the one or more scheduled transmissions in the second BWP, the second CC, or both.

In some examples, the at least one transmission configuration indicates activation of the one or more scheduled transmissions in the second BWP, and the scheduled transmission receiving component 1535 may be configured as or otherwise support a means for communicating, via the second BWP, the second CC, or both, a scheduled transmission of the one or more scheduled transmissions using a second configuration of the at least one transmission configuration for the second BWP, the second CC, or both, after the defined time period.

In some examples, the multiple CCs include one or more CCs that at least partially overlap in a frequency domain or are non-overlapping in the frequency domain.

In some examples, the at least one transmission configuration is indicative of a linkage between the multiple BWPs, the multiple CCs, or both.

In some examples, the at least one transmission configuration includes one or more time domain allocation parameters, one or more frequency domain allocation parameters, one or more modulation and coding scheme parameters, one or more periodicity parameters, or any combination thereof. In some examples, the control message includes an RRC message.

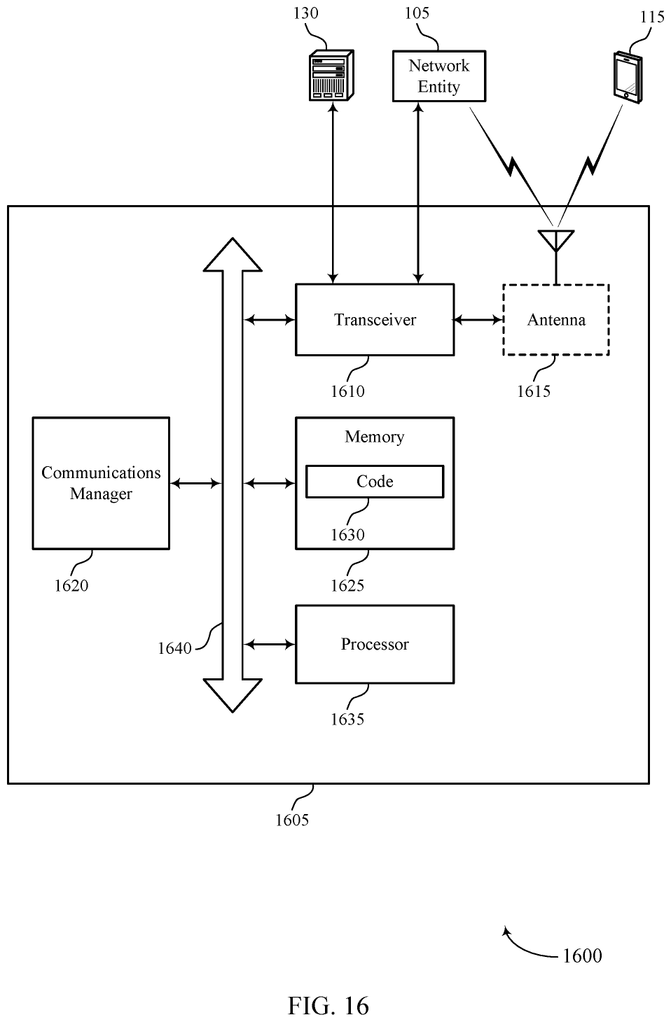

FIG. 16 shows a diagram of a system 1600 including a device 1605 that supports CG and SPS for frequent BWP and CC switching in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting CG and SPS for frequent BWP and CC switching). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may broadly refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity in accordance with examples as disclosed herein. For example, the communications manager 1620 may be configured as or otherwise support a means for outputting a control message that indicates at least one transmission configuration for BWP switching between multiple BWPs, for CC switching between multiple CCs, or both, the at least one transmission configuration associated with a set of multiple scheduled transmissions at a UE. The communications manager 1620 may be configured as or otherwise support a means for outputting a switch command to switch from a first BWP to a second BWP, from a first CC to a second CC, or both. The communications manager 1620 may be configured as or otherwise support a means for obtaining one or more scheduled transmissions of the set of multiple scheduled transmissions in accordance with the at least one transmission configuration.

By including or configuring the communications manager 1620 in accordance with examples as described herein, the device 1605 may support techniques for improved communication reliability for SPS and CG communications during frequent BWP or CC switching, reduced latency based on reduced activation signaling, reduced power consumption from the network and UE perspective based on improved signaling overhead, improved coordination between devices, and longer battery life.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of CG and SPS for frequent BWP and CC switching as described herein, or the processor 1635 and the memory 1625 may be otherwise configured to perform or support such operations.

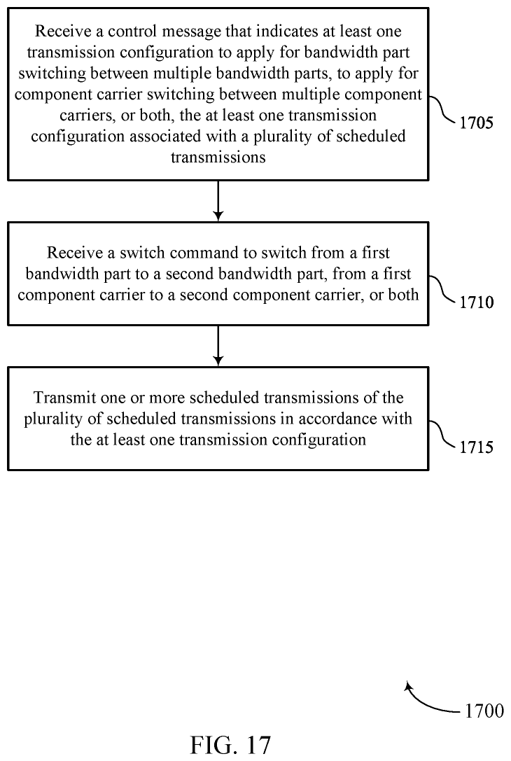

FIG. 17 shows a flowchart illustrating a method 1700 that supports CG and SPS for frequent BWP and CC switching in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a control message that indicates at least one transmission configuration to apply for BWP switching between multiple BWPs, to apply for CC switching between multiple CCs, or both, the at least one transmission configuration associated with a set of multiple scheduled transmissions. The operations of 1705 may be performed in accordance with examples as disclosed herein. In some examples, aspects of the operations of 1705 may be performed by a transmission configuration receiving component 1125 as described with reference to FIG. 11.

At 1710, the method may include receiving a switch command to switch from a first BWP to a second BWP, from a first CC to a second CC, or both. The operations of 1710 may be performed in accordance with examples as disclosed herein. In some examples, aspects of the operations of 1710 may be performed by a switching application component 1130 as described with reference to FIG. 11.

At 1715, the method may include transmitting one or more scheduled transmissions of the set of multiple scheduled transmissions in accordance with the at least one transmission configuration. The operations of 1715 may be performed in accordance with examples as disclosed herein. In some examples, aspects of the operations of 1715 may be performed by a scheduled transmission component 1135 as described with reference to FIG. 11.

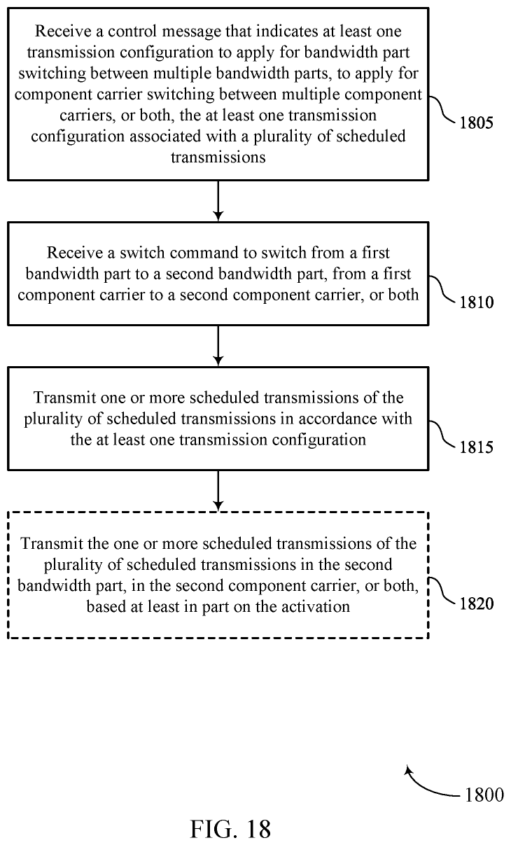

FIG. 18 shows a flowchart illustrating a method 1800 that supports CG and SPS for frequent BWP and CC switching in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving a control message that indicates at least one transmission configuration to apply for BWP switching between multiple BWPs, to apply for CC switching between multiple CCs, or both, the at least one transmission configuration associated with a set of multiple scheduled transmissions. The operations of 1805 may be performed in accordance with examples as disclosed herein. In some examples, aspects of the operations of 1805 may be performed by a transmission configuration receiving component 1125 as described with reference to FIG. 11.

At 1810, the method may include receiving a switch command to switch from a first BWP to a second BWP, from a first CC to a second CC, or both. The operations of 1810 may be performed in accordance with examples as disclosed herein. In some examples, aspects of the operations of 1810 may be performed by a switching application component 1130 as described with reference to FIG. 11.

At 1815, the method may include transmitting one or more scheduled transmissions of the set of multiple scheduled transmissions in accordance with the at least one transmission configuration. The operations of 1815 may be performed in accordance with examples as disclosed herein. In some examples, aspects of the operations of 1815 may be performed by a scheduled transmission component 1135 as described with reference to FIG. 11.

At 1820, the method may include transmitting the one or more scheduled transmissions of the set of multiple scheduled transmissions in the second BWP, in the second CC, or both, based on the activation. The operations of 1820 may be performed in accordance with examples as disclosed herein. In some examples, aspects of the operations of 1820 may be performed by a scheduled transmission component 1135 as described with reference to FIG. 11.

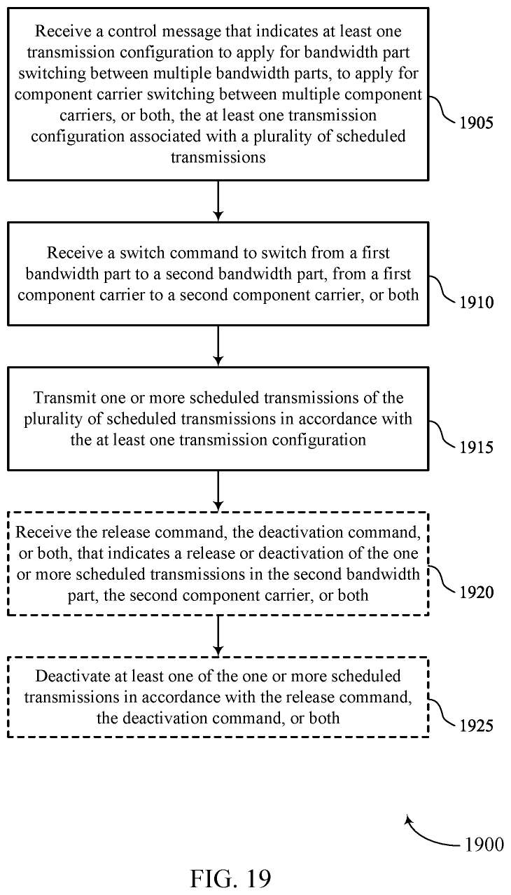

FIG. 19 shows a flowchart illustrating a method 1900 that supports CG and SPS for frequent BWP and CC switching in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving a control message that indicates at least one transmission configuration to apply for BWP switching between multiple BWPs, to apply for CC switching between multiple CCs, or both, the at least one transmission configuration associated with a set of multiple scheduled transmissions. The operations of 1905 may be performed in accordance with examples as disclosed herein. In some examples, aspects of the operations of 1905 may be performed by a transmission configuration receiving component 1125 as described with reference to FIG. 11.

At 1910, the method may include receiving a switch command to switch from a first BWP to a second BWP, from a first CC to a second CC, or both. The operations of 1910 may be performed in accordance with examples as disclosed herein. In some examples, aspects of the operations of 1910 may be performed by a switching application component 1130 as described with reference to FIG. 11.

At 1915, the method may include transmitting one or more scheduled transmissions of the set of multiple scheduled transmissions in accordance with the at least one transmission configuration. The operations of 1915 may be performed in accordance with examples as disclosed herein. In some examples, aspects of the operations of 1915 may be performed by a scheduled transmission component 1135 as described with reference to FIG. 11.

At 1920, the method may include receiving the release command, the deactivation command, or both, that indicates a release or deactivation of the one or more scheduled transmissions in the second BWP, the second CC, or both. The operations of 1920 may be performed in accordance with examples as disclosed herein. In some examples, aspects of the operations of 1920 may be performed by a transmission configuration release component 1140 as described with reference to FIG. 11.

At 1925, the method may include deactivating at least one of the one or more scheduled transmissions in accordance with the release command, the deactivation command, or both. The operations of 1925 may be performed in accordance with examples as disclosed herein. In some examples, aspects of the operations of 1925 may be performed by a transmission configuration release component 1140 as described with reference to FIG. 11.

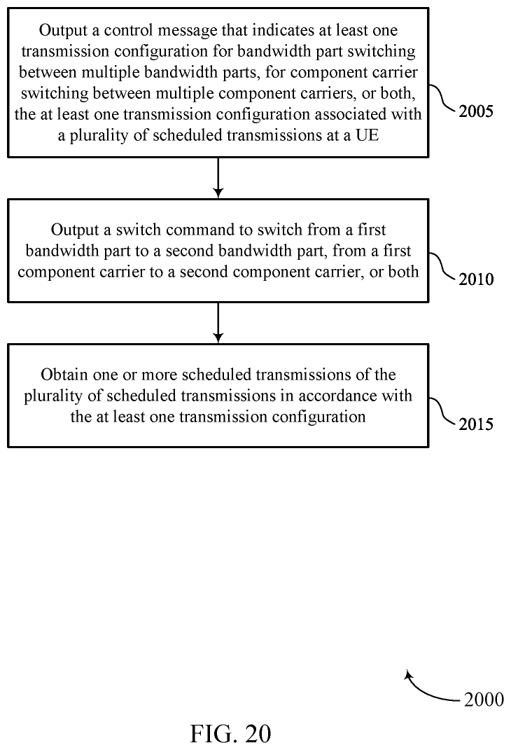

FIG. 20 shows a flowchart illustrating a method 2000 that supports CG and SPS for frequent BWP and CC switching in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting a control message that indicates at least one transmission configuration for BWP switching between multiple BWPs, for CC switching between multiple CCs, or both, the at least one transmission configuration associated with a set of multiple scheduled transmissions at a UE. The operations of 2005 may be performed in accordance with examples as disclosed herein. In some examples, aspects of the operations of 2005 may be performed by a transmission configuration output component 1525 as described with reference to FIG. 15.

At 2010, the method may include outputting a switch command to switch from a first BWP to a second BWP, from a first CC to a second CC, or both. The operations of 2010 may be performed in accordance with examples as disclosed herein. In some examples, aspects of the operations of 2010 may be performed by a switch command output component 1530 as described with reference to FIG. 15.

At 2015, the method may include obtaining one or more scheduled transmissions of the set of multiple scheduled transmissions in accordance with the at least one transmission configuration. The operations of 2015 may be performed in accordance with examples as disclosed herein. In some examples, aspects of the operations of 2015 may be performed by a scheduled transmission receiving component 1535 as described with reference to FIG. 15.

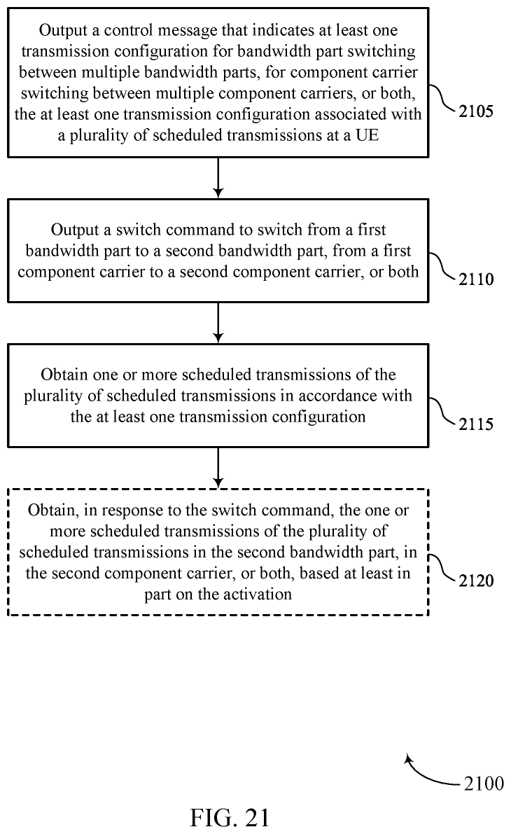

FIG. 21 shows a flowchart illustrating a method 2100 that supports CG and SPS for frequent BWP and CC switching in accordance with one or more aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2105, the method may include outputting a control message that indicates at least one transmission configuration for BWP switching between multiple BWPs, for CC switching between multiple CCs, or both, the at least one transmission configuration associated with a set of multiple scheduled transmissions at a UE. The operations of 2105 may be performed in accordance with examples as disclosed herein. In some examples, aspects of the operations of 2105 may be performed by a transmission configuration output component 1525 as described with reference to FIG. 15.

At 2110, the method may include outputting a switch command to switch from a first BWP to a second BWP, from a first CC to a second CC, or both. The operations of 2110 may be performed in accordance with examples as disclosed herein. In some examples, aspects of the operations of 2110 may be performed by a switch command output component 1530 as described with reference to FIG. 15.

At 2115, the method may include obtaining one or more scheduled transmissions of the set of multiple scheduled transmissions in accordance with the at least one transmission configuration. The operations of 2115 may be performed in accordance with examples as disclosed herein. In some examples, aspects of the operations of 2115 may be performed by a scheduled transmission receiving component 1535 as described with reference to FIG. 15.

At 2120, the method may include obtaining, in response to the switch command, the one or more scheduled transmissions of the set of multiple scheduled transmissions in the second BWP, in the second CC, or both, based on the activation. The operations of 2120 may be performed in accordance with examples as disclosed herein. In some examples, aspects of the operations of 2120 may be performed by a scheduled transmission receiving component 1535 as described with reference to FIG. 15.

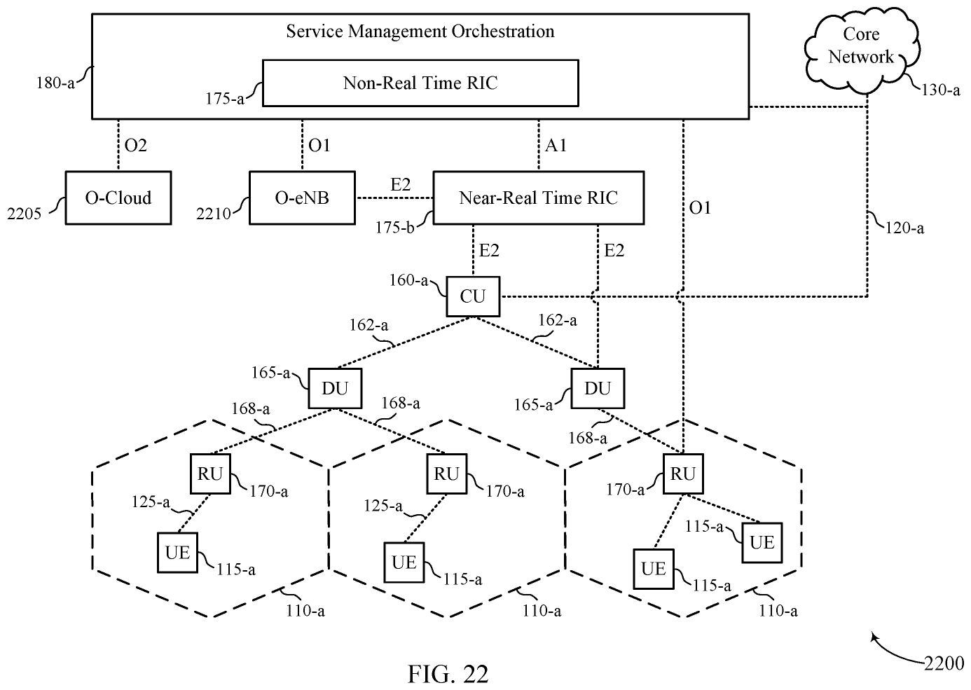

FIG. 22 illustrates an example of a network architecture 2200 (e.g., a disaggregated base station architecture, a disaggregated RAN architecture) that supports configured grant and semi-persistent scheduling for frequent bandwidth part and component carrier switching in accordance with one or more aspects of the present disclosure. The network architecture 2200 may illustrate an example for implementing one or more aspects of the wireless communications system 100. The network architecture 2200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 2200 (e.g., CUs 160-a, DUs 165-a, RUs 170-a, Non-RT RICs 175-a, Near-RT RICs 175-b, SMOs 180-a, Open Clouds (O-Clouds) 2205, Open eNBs (O-eNBs) 2210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

The following provides an overview of aspects of the present disclosure:

Aspect 1: An apparatus for wireless communication at a UE, comprising a processor; and memory coupled with the processor, the processor configured to: receive a control message that indicates at least one transmission configuration to apply for BWP switching between multiple BWPs, to apply for CC switching between multiple CCs, or both, the at least one transmission configuration associated with a plurality of scheduled transmissions; receive a switch command to switch from a first BWP to a second BWP, from a first CC to a second CC, or both; and transmit one or more scheduled transmissions of the plurality of scheduled transmissions in accordance with the at least one transmission configuration.

Aspect 2: The apparatus of aspect 29, wherein the at least one transmission configuration comprises an uplink CG configuration, an SPS configuration, or both.

Aspect 3: The apparatus of any of aspects 29 through 30, wherein the control message further comprises an index that identifies each BWP of the multiple BWPs or each CC of the multiple CCs to which the at least one transmission configuration applies.

Aspect 4: The apparatus of any of aspects 29 through 31, wherein the at least one transmission configuration indicates an activation of the one or more scheduled transmissions in the second BWP, in the second CC, or both, the apparatus further configured to: transmit the one or more scheduled transmissions of the plurality of scheduled transmissions in the second BWP, in the second CC, or both, based at least in part on the activation.

Aspect 5: The apparatus of any of aspects 29 through 32, wherein the at least one transmission configuration comprises a single transmission configuration for the first BWP and the second BWP, the first CC and the second CC, or both.

Aspect 6: The apparatus of any of aspects 29 through 33, wherein the at least one transmission configuration comprises a common transmission configuration for the first BWP and the second BWP, a first dedicated transmission configuration for the first BWP, and a second dedicated transmission configuration for the second BWP.

Aspect 7: The apparatus of any of aspects 29 through 34, wherein the at least one transmission configuration comprises a common transmission configuration for the first CC and the second CC, a first dedicated transmission configuration for the first CC, and a second dedicated transmission configuration for the second CC.

Aspect 8: The apparatus of any of aspects 29 through 35, wherein the at least one transmission configuration comprises a first transmission configuration for the first BWP and a second transmission configuration for the second BWP, a first transmission configuration for the first CC and a second transmission configuration for the second CC, or both.

Aspect 9: The apparatus of any of aspects 29 through 36, wherein the at least one transmission configuration indicates an activation of the one or more scheduled transmissions in the second BWP, the second CC, or both, until reception of a deactivation command or a release command, the apparatus further configured to: receive the release command, the deactivation command, or both, that indicates a release or deactivation of the one or more scheduled transmissions in the second BWP, the second CC, or both; and deactivate at least one of the one or more scheduled transmissions in accordance with the release command, the deactivation command, or both.

Aspect 10: The apparatus of any of aspects 29 through 37, wherein the at least one transmission configuration indicates activation of the one or more scheduled transmissions in the second BWP, the second CC, or both, using a first configuration of the first BWP, the first CC, or both, for a defined time period after receipt of the switch command, the apparatus further configured to: communicate, via the second BWP, the second CC, or both, a scheduled transmission of the one or more scheduled transmissions using a second configuration of the at least one transmission configuration for the second BWP, the second CC, or both, after the defined time period.

Aspect 11: The apparatus of any of aspects 29 through 38, wherein the multiple CCs comprise one or more CCs that at least partially overlap in a frequency domain or are non-overlapping in the frequency domain.

Aspect 12: The apparatus of any of aspects 29 through 39, wherein the at least one transmission configuration is indicative of a linkage between the multiple BWPs, the multiple CCs, or both.

Aspect 13: The apparatus of any of aspects 29 through 40, wherein the at least one transmission configuration comprises one or more time domain allocation parameters, one or more frequency domain allocation parameters, one or more MCS parameters, one or more periodicity parameters, or any combination thereof.

Aspect 14: The apparatus of any of aspects 29 through 41, wherein the control message comprises a radio resource control message.

Aspect 15: An apparatus for wireless communication at a network entity comprising a processor; and memory coupled with the processor, the processor configured to: output a control message that indicates at least one transmission configuration for BWP switching between multiple BWPs, for CC switching between multiple CCs, or both, the at least one transmission configuration associated with a plurality of scheduled transmissions at a UE; output a switch command to switch from a first BWP to a second BWP, from a first CC to a second CC, or both; and obtain one or more scheduled transmissions of the plurality of scheduled transmissions in accordance with the at least one transmission configuration.

Aspect 16: The apparatus of aspect 43, wherein the at least one transmission configuration comprises an uplink CG configuration, an SPS configuration, or both.

Aspect 17: The apparatus of any of aspects 43 through 44, wherein the control message further comprises an index that identifies each BWP of the multiple BWPs or each CC of the multiple CCs to which the at least one transmission configuration applies.

Aspect 18: The apparatus of any of aspects 43 through 45, wherein the at least one transmission configuration indicates an activation of the one or more scheduled transmissions in the second BWP, in the second CC, or both, the apparatus further configured to: obtain the one or more scheduled transmissions of the plurality of scheduled transmissions in the second BWP, in the second CC, or both, based at least in part on the activation.

Aspect 19: The apparatus of any of aspects 43 through 46, wherein the at least one transmission configuration comprises a single transmission configuration to apply for the first BWP and the second BWP, the first CC and the second CC, or both.

Aspect 20: The apparatus of any of aspects 43 through 47, wherein the at least one transmission configuration comprises a common transmission configuration to apply for the first BWP and the second BWP, and further indicates a first dedicated transmission configuration for the first BWP and a second dedicated transmission configuration for the second BWP.

Aspect 21: The apparatus of any of aspects 43 through 48, wherein the at least one transmission configuration comprises a common transmission configuration for the first CC and the second CC, and a first dedicated transmission configuration for the first CC and a second dedicated transmission configuration for the second CC.

Aspect 22: The apparatus of any of aspects 43 through 49, wherein the at least one transmission configuration comprises a first transmission configuration for the first BWP and a second transmission configuration for the second BWP, a first transmission configuration for the first CC and a second transmission configuration for the second CC, or both.

Aspect 23: The apparatus of any of aspects 43 through 50, wherein the at least one transmission configuration indicates an activation of the one or more scheduled transmissions in the second BWP, the second CC, or both, until reception of a deactivation command or a release command, the apparatus further configured to: output the release command, the deactivation command, or both, that indicates a release or deactivation of at least one of the one or more scheduled transmissions in the second BWP, the second CC, or both.

Aspect 24: The apparatus of any of aspects 43 through 51, wherein the at least one transmission configuration indicates activation of the one or more scheduled transmissions in the second BWP, the second CC, or both, using a first configuration of the first BWP, the first CC, or both, for a defined time period after output of the switch command, the apparatus further configured to: communicate, via the second BWP, the second CC, or both, a scheduled transmission of the one or more scheduled transmissions using a second configuration of the at least one transmission configuration for the second BWP, the second CC, or both, after the defined time period.

Aspect 25: The apparatus of any of aspects 43 through 52, wherein the multiple CCs comprise one or more CCs that at least partially overlap in a frequency domain or are non-overlapping in the frequency domain.

Aspect 26: The apparatus of any of aspects 43 through 53, wherein the at least one transmission configuration is indicative of a linkage between the multiple BWPs, the multiple CCs, or both.

Aspect 27: The apparatus of any of aspects 43 through 54, wherein the at least one transmission configuration comprises one or more time domain allocation parameters, one or more frequency domain allocation parameters, one or more MCS parameters, one or more periodicity parameters, or any combination thereof.

Aspect 28: The apparatus of any of aspects 43 through 55, wherein the control message comprises a radio resource control message.

Aspect 29: A method for wireless communication at a UE, comprising: receiving a control message that indicates at least one transmission configuration to apply for BWP switching between multiple BWPs, to apply for CC switching between multiple CCs, or both, the at least one transmission configuration associated with a plurality of scheduled transmissions; receiving a switch command to switch from a first BWP to a second BWP, from a first CC to a second CC, or both; and transmitting one or more scheduled transmissions of the plurality of scheduled transmissions in accordance with the at least one transmission configuration.

Aspect 30: The method of aspect 29, the at least one transmission configuration comprising an uplink CG configuration, an SPS configuration, or both.

Aspect 31: The method of any of aspects 29 through 30, the control message further comprising an index that identifies each BWP of the multiple BWPs or each CC of the multiple CCs to which the at least one transmission configuration applies.

Aspect 32: The method of any of aspects 29 through 31, the at least one transmission configuration indicating an activation of the one or more scheduled transmissions in the second BWP, in the second CC, or both, the method further comprising: transmitting the one or more scheduled transmissions of the plurality of scheduled transmissions in the second BWP, in the second CC, or both, based at least in part on the activation.

Aspect 33: The method of any of aspects 29 through 32, the at least one transmission configuration comprising a single transmission configuration for the first BWP and the second BWP, the first CC and the second CC, or both.

Aspect 34: The method of any of aspects 29 through 33, the at least one transmission configuration comprising a common transmission configuration for the first BWP and the second BWP, a first dedicated transmission configuration for the first BWP, and a second dedicated transmission configuration for the second BWP.

Aspect 35: The method of any of aspects 29 through 34, the at least one transmission configuration comprising a common transmission configuration for the first CC and the second CC, a first dedicated transmission configuration for the first CC, and a second dedicated transmission configuration for the second CC.

Aspect 36: The method of any of aspects 29 through 35, the at least one transmission configuration comprising a first transmission configuration for the first BWP and a second transmission configuration for the second BWP, a first transmission configuration for the first CC and a second transmission configuration for the second CC, or both.

Aspect 37: The method of any of aspects 29 through 36, the at least one transmission configuration indicating an activation of the one or more scheduled transmissions in the second BWP, the second CC, or both, until reception of a deactivation command or a release command, the method further comprising: receiving the release command, the deactivation command, or both, that indicates a release or deactivation of the one or more scheduled transmissions in the second BWP, the second CC, or both; and deactivating at least one of the one or more scheduled transmissions in accordance with the release command, the deactivation command, or both.

Aspect 38: The method of any of aspects 29 through 37, the at least one transmission configuration indicating activation of the one or more scheduled transmissions in the second BWP, the second CC, or both, using a first configuration of the first BWP, the first CC, or both, for a defined time period after receiving the switch command, the method further comprising: communicating, via the second BWP, the second CC, or both, a scheduled transmission of the one or more scheduled transmissions using a second configuration of the at least one transmission configuration for the second BWP, the second CC, or both, after the defined time period.

Aspect 39: The method of any of aspects 29 through 38, the multiple CCs comprising one or more CCs that at least partially overlap in a frequency domain or are non-overlapping in the frequency domain.

Aspect 40: The method of any of aspects 29 through 39, the at least one transmission configuration being indicative of a linkage between the multiple BWPs, the multiple CCs, or both.

Aspect 41: The method of any of aspects 29 through 40, the at least one transmission configuration comprising one or more time domain allocation parameters, one or more frequency domain allocation parameters, one or more MCS parameters, one or more periodicity parameters, or any combination thereof.

Aspect 42: The method of any of aspects 29 through 41, the control message comprising an RRC message.

Aspect 43: A method for wireless communication at a network entity, comprising: outputting a control message that indicates at least one transmission configuration for BWP switching between multiple BWPs, for CC switching between multiple CCs, or both, the at least one transmission configuration associated with a plurality of scheduled transmissions at a UE; outputting a switch command to switch from a first BWP to a second BWP, from a first CC to a second CC, or both; and obtaining one or more scheduled transmissions of the plurality of scheduled transmissions in accordance with the at least one transmission configuration.

Aspect 44: The method of aspect 43, the at least one transmission configuration comprising an uplink CG configuration, an SPS configuration, or both.

Aspect 45: The method of any of aspects 43 through 44, the control message further comprising an index that identifies each BWP of the multiple BWPs or each CC of the multiple CCs to which the at least one transmission configuration applies.

Aspect 46: The method of any of aspects 43 through 45, the at least one transmission configuration indicating an activation of the one or more scheduled transmissions in the second BWP, in the second CC, or both, the method further comprising: obtaining the one or more scheduled transmissions of the plurality of scheduled transmissions in the second BWP, in the second CC, or both, based at least in part on the activation.

Aspect 47: The method of any of aspects 43 through 46, the at least one transmission configuration comprising a single transmission configuration to apply for the first BWP and the second BWP, the first CC and the second CC, or both.

Aspect 48: The method of any of aspects 43 through 47, the at least one transmission configuration comprising a common transmission configuration to apply for the first BWP and the second BWP, and further indicates a first dedicated transmission configuration for the first BWP and a second dedicated transmission configuration for the second BWP.

Aspect 49: The method of any of aspects 43 through 48, the at least one transmission configuration comprising a common transmission configuration for the first CC and the second CC, and a first dedicated transmission configuration for the first CC and a second dedicated transmission configuration for the second CC.

Aspect 50: The method of any of aspects 43 through 49, the at least one transmission configuration comprising a first transmission configuration for the first BWP and a second transmission configuration for the second BWP, a first transmission configuration for the first CC and a second transmission configuration for the second CC, or both.

Aspect 51: The method of any of aspects 43 through 50, the at least one transmission configuration indicating an activation of the one or more scheduled transmissions in the second BWP, the second CC, or both, until reception of a deactivation command or a release command, the method further comprising: outputting the release command, the deactivation command, or both, that indicates a release or deactivation of at least one of the one or more scheduled transmissions in the second BWP, the second CC, or both.

Aspect 52: The method of any of aspects 43 through 51, the at least one transmission configuration indicating activation of the one or more scheduled transmissions in the second BWP, the second CC, or both, using a first configuration of the first BWP, the first CC, or both, for a defined time period after output of the switch command, the method further comprising: communicating, via the second BWP, the second CC, or both, a scheduled transmission of the one or more scheduled transmissions using a second configuration of the at least one transmission configuration for the second BWP, the second CC, or both, after the defined time period.

Aspect 53: The method of any of aspects 43 through 52, the multiple CCs comprising one or more CCs that at least partially overlap in a frequency domain or are non-overlapping in the frequency domain.

Aspect 54: The method of any of aspects 43 through 53, the at least one transmission configuration being indicative of a linkage between the multiple BWPs, the multiple CCs, or both.

Aspect 55: The method of any of aspects 43 through 54, the at least one transmission configuration comprising one or more time domain allocation parameters, one or more frequency domain allocation parameters, one or more MCS parameters, one or more periodicity parameters, or any combination thereof.

Aspect 56: The method of any of aspects 43 through 55, the control message comprising an RRC message.

Aspect 57: An apparatus for wireless communication at a UE, comprising at least one means for performing a method of any of aspects 29 through 42.

Aspect 58: A non-transitory computer-readable medium storing code for wireless communication at a UE, the code comprising instructions executable by a processor to perform a method of any of aspects 29 through 42.

Aspect 59: An apparatus for wireless communication at a network entity, comprising at least one means for performing a method of any of aspects 43 through 56.

Aspect 60: A non-transitory computer-readable medium storing code for wireless communication at a network entity, the code comprising instructions executable by a processor to perform a method of any of aspects 43 through 56.

It should be noted that the methods described herein describe possible implementations, and that the operations may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example method that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in flow diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor configured to:
receive a control message that indicates at least one transmission configuration to apply for bandwidth part switching between multiple bandwidth parts, to apply for component carrier switching between multiple component carriers, or both, the at least one transmission configuration associated with a plurality of scheduled transmissions;
receive a switch command to switch from a first bandwidth part to a second bandwidth part, from a first component carrier to a second component carrier, or both; and
transmit one or more scheduled transmissions of the plurality of scheduled transmissions in accordance with the at least one transmission configuration.

2. The apparatus of claim 1, wherein the at least one transmission configuration comprises an uplink configured grant configuration, a semi-persistent scheduling configuration, or both.

3. The apparatus of claim 1, wherein the control message further comprises an index that identifies each bandwidth part of the multiple bandwidth parts or each component carrier of the multiple component carriers to which the at least one transmission configuration applies.

4. The apparatus of claim 1, wherein the at least one transmission configuration indicates an activation of the one or more scheduled transmissions in the second bandwidth part, in the second component carrier, or both, and wherein the apparatus is further configured to:
transmit the one or more scheduled transmissions of the plurality of scheduled transmissions in the second bandwidth part, in the second component carrier, or both, based at least in part on the activation.

5. The apparatus of claim 1, wherein the at least one transmission configuration comprises a single transmission configuration for the first bandwidth part and the second bandwidth part, the first component carrier and the second component carrier, or both.

6. The apparatus of claim 1, wherein the at least one transmission configuration comprises a common transmission configuration for the first bandwidth part and the second bandwidth part, a first dedicated transmission configuration for the first bandwidth part, and a second dedicated transmission configuration for the second bandwidth part.

7. The apparatus of claim 1, wherein the at least one transmission configuration comprises a common transmission configuration for the first component carrier and the second component carrier, a first dedicated transmission configuration for the first component carrier, and a second dedicated transmission configuration for the second component carrier.

8. The apparatus of claim 1, wherein the at least one transmission configuration comprises a first transmission configuration for the first bandwidth part and a second transmission configuration for the second bandwidth part, a first transmission configuration for the first component carrier and a second transmission configuration for the second component carrier, or both.

9. The apparatus of claim 1, wherein the at least one transmission configuration indicates an activation of the one or more scheduled transmissions in the second bandwidth part, the second component carrier, or both, until reception of a deactivation command or a release command, and wherein the processor is further configured to:
receive the release command, the deactivation command, or both, that indicates a release or deactivation of the one or more scheduled transmissions in the second bandwidth part, the second component carrier, or both; and
deactivate at least one of the one or more scheduled transmissions in accordance with the release command, the deactivation command, or both.

10. The apparatus of claim 1, wherein the at least one transmission configuration indicates activation of the one or more scheduled transmissions in the second bandwidth part, the second component carrier, or both, using a first configuration of the first bandwidth part, the first component carrier, or both, for a defined time period after receipt of the switch command, and wherein the processor is further configured to:
communicate, via the second bandwidth part, the second component carrier, or both, a scheduled transmission of the one or more scheduled transmissions using a second configuration of the at least one transmission configuration for the second bandwidth part, the second component carrier, or both, after the defined time period.

11. The apparatus of claim 1, wherein the multiple component carriers being one or more component carriers that at least partially overlap in a frequency domain or are non-overlapping in the frequency domain.

12. The apparatus of claim 1, wherein the at least one transmission configuration is indicative of a linkage between the multiple bandwidth parts, the multiple component carriers, or both.

13. The apparatus of claim 1, wherein the at least one transmission configuration comprises one or more time domain allocation parameters, one or more frequency domain allocation parameters, one or more modulation and coding scheme parameters, one or more periodicity parameters, or any combination thereof.

14. The apparatus of claim 1, wherein the apparatus further comprises one or more antennas, wherein the one or more antennas and the processor are configured to:
receive the control message, wherein the control message comprises a radio resource control message.

15. An apparatus for wireless communication at a network entity, comprising:
a processor; and
memory coupled with the processor, the processor configured to:
output a control message that indicates at least one transmission configuration for bandwidth part switching between multiple bandwidth parts, for component carrier switching between multiple component carriers, or both, the at least one transmission configuration associated with a plurality of scheduled transmissions at a user equipment (UE);
output a switch command to switch from a first bandwidth part to a second bandwidth part, from a first component carrier to a second component carrier, or both; and
obtain one or more scheduled transmissions of the plurality of scheduled transmissions in accordance with the at least one transmission configuration.

16. The apparatus of claim 15, wherein the at least one transmission configuration comprises an uplink configured grant configuration, a semi-persistent scheduling configuration, or both.

17. The apparatus of claim 15, wherein the control message further comprises an index that identifies each bandwidth part of the multiple bandwidth parts or each component carrier of the multiple component carriers to which the at least one transmission configuration applies.

18. The apparatus of claim 15, wherein the at least one transmission configuration indicates an activation of the one or more scheduled transmissions in the second bandwidth part, in the second component carrier, or both, and wherein the processor is further configured to:
obtain the one or more scheduled transmissions of the plurality of scheduled transmissions in the second bandwidth part, in the second component carrier, or both, based at least in part on the activation.

19. The apparatus of claim 15, wherein the at least one transmission configuration comprises a single transmission configuration to apply for the first bandwidth part and the second bandwidth part, the first component carrier and the second component carrier, or both.

20. The apparatus of claim 15, wherein the at least one transmission configuration comprises a common transmission configuration to apply for the first bandwidth part and the second bandwidth part, and further indicates a first dedicated transmission configuration for the first bandwidth part and a second dedicated transmission configuration for the second bandwidth part.

21. The apparatus of claim 15, wherein the at least one transmission configuration comprises a common transmission configuration for the first component carrier and the second component carrier, and a first dedicated transmission configuration for the first component carrier and a second dedicated transmission configuration for the second component carrier.

22. The apparatus of claim 15, wherein the at least one transmission configuration comprises a first transmission configuration for the first bandwidth part and a second transmission configuration for the second bandwidth part, a first transmission configuration for the first component carrier and a second transmission configuration for the second component carrier, or both.

23. The apparatus of claim 15, wherein the at least one transmission configuration indicates an activation of the one or more scheduled transmissions in the second bandwidth part, the second component carrier, or both, until reception of a deactivation command or a release command, and wherein the processor is further configured to:
output the release command, the deactivation command, or both, that indicates a release or deactivation of at least one of the one or more scheduled transmissions in the second bandwidth part, the second component carrier, or both.

24. The apparatus of claim 15, wherein the at least one transmission configuration indicates activation of the one or more scheduled transmissions in the second bandwidth part, the second component carrier, or both, using a first configuration of the first bandwidth part, the first component carrier, or both, for a defined time period after output of the switch command, and wherein the processor is further configured to:
communicate, via the second bandwidth part, the second component carrier, or both, a scheduled transmission of the one or more scheduled transmissions using a second configuration of the at least one transmission configuration for the second bandwidth part, the second component carrier, or both, after the defined time period.

25. The apparatus of claim 15, wherein the multiple component carriers comprise one or more component carriers that at least partially overlap in a frequency domain or are non-overlapping in the frequency domain.

26. The apparatus of claim 15, wherein the at least one transmission configuration is indicative of a linkage between the multiple bandwidth parts, the multiple component carriers, or both.

27. The apparatus of claim 15, wherein the at least one transmission configuration comprises one or more time domain allocation parameters, one or more frequency domain allocation parameters, one or more modulation and coding scheme parameters, one or more periodicity parameters, or any combination thereof.

28. The apparatus of claim 15, further comprising:
one or more antennas, wherein the one or more antennas and the processor are configured to:
output the control message, wherein the control message comprises a radio resource control message.

29. A method for wireless communication at a user equipment (UE), comprising:
receiving a control message that indicates at least one transmission configuration to apply for bandwidth part switching between multiple bandwidth parts, to apply for component carrier switching between multiple component carriers, or both, the at least one transmission configuration associated with a plurality of scheduled transmissions;
receiving a switch command to switch from a first bandwidth part to a second bandwidth part, from a first component carrier to a second component carrier, or both; and
transmitting one or more scheduled transmissions of the plurality of scheduled transmissions in accordance with the at least one transmission configuration.

30. A method for wireless communication at a network entity, comprising:
outputting a control message that indicates at least one transmission configuration for bandwidth part switching between multiple bandwidth parts, for component carrier switching between multiple component carriers, or both, the at least one transmission configuration associated with a plurality of scheduled transmissions at a user equipment (UE);
outputting a switch command to switch from a first bandwidth part to a second bandwidth part, from a first component carrier to a second component carrier, or both; and
obtaining one or more scheduled transmissions of the plurality of scheduled transmissions in accordance with the at least one transmission configuration.
